(19) United States
(12) Patent Application Publication
(10) Pub. No.: US 2020/0126597 A1
(43) Pub. Date: Apr. 23, 2020

(54) Electronic Device, Cover Seal and Method for Applying Cover Seal

(71) Applicant: NITTO DENKO CORPORATION, Osaka (JP)

(72) Inventors: Kenji FURUTA, Osaka (JP); Akira HIRAO, Osaka (JP); Tatsuya SUZUKI, Osaka (JP); Hiroki IEDA, Osaka (JP)

(21) Appl. No.: 16/599,388

(22) Filed: Oct. 11, 2019

(30) Foreign Application Priority Data
Oct. 22, 2018 (JP) 2018-198526

(51) Int. Cl. G11B 33/14; B32B 15/09; B32B 15/20

(52) U.S. Cl. CPC G11B 33/148; B32B 15/09; G11B 2005/0021; B32B 2405/00; B32B 2307/7242; B32B 15/20

(57) ABSTRACT

Provided is an electronic device capable of bringing about excellent airtightness. The electronic device provided by this invention comprises a housing that forms an internal space to house components, and a cover seal. The housing has an opening and/or gap through which gases can move between the internal space and outside of the housing. The cover seal is bonded to the housing, covering the opening and/or gap. The cover seal is formed of at least one PSA sheet having a gas barrier layer and a PSA layer provided at least on one face of the gas barrier layer. The bonding interface between the housing and the cover seal has, along its surface, a first bonding area, a non-bonding area and a second bonding area in this order from the opening and/or gap towards the outside.

### CROSS-REFERENCE

The present invention claims priority to Japanese Patent Application No. 2018-198526 filed on Oct. 22, 2018; and the entire content thereof is incorporated herein by reference.

### BACKGROUND OF THE INVENTION

### 1. Field of the Invention

The present invention relates to an electronic device, a cover seal and a method for applying a cover seal.

### 2. Description of the Related Art

In general, pressure-sensitive adhesive (PSA) exists as a soft solid (a viscoelastic material) in a room temperature range and has a property to adhere easily to an adherend with some pressure applied. For such a property, PSA is widely used in a form of, for instance, an on-substrate PSA sheet having a PSA layer on a support substrate, for purposes such as bonding, fastening, protection and sealing in various applications. For instance, technical literatures related to PSA sheets that airtightly seal internal spaces of magnetic disc devices (which are a type of electronic devices) include Japanese Patent Application Publication Nos. 2014-162874, 2017-014478 and 2017-160417.

### SUMMARY OF THE INVENTION

These PSA sheets all comprise non-breathable substrates and are used in magnetic disc devices such as hard disc drives (HDD), in embodiments to seal their internal spaces where magnetic discs (typically HD) are contained. In particular, a void space that can be present between a cover member and a housing base member in which the magnetic disc is placed can be covered and sealed with a PSA sheet so as to obtain airtightness for the internal space of the device. Such airtight properties may be essential and particularly important in a type of device whose internal space is filled with a low-density gas such as helium in order to reduce the influence of air flow generated by the spinning disc.

Lately, studies are underway on magnetic disc devices using HAMR (heat-assisted magnetic recording) for further increases in capacity. In short, HAMR is a technology that uses a laser beam to increase their surface recording densities. In this technology, the presence of internal moisture attenuates the laser beam and badly impacts on the recording life (the number of times that it can be overwritten). Thus, it is desirable to exclude moisture as much as possible. As described above, there are many electronic devices, at least part of whose internal space needs to be highly airtight.

As a result of studies based on empirical testing to obtain greater airtightness with internal spaces of devices, the present inventors have successfully developed a technology capable of providing high airtightness to internal spaces of devices to complete this invention. In other words, an objective of the present invention is to provide an electronic device capable of bringing about excellent airtightness. Another objective of this invention is to provide a cover seal capable of providing excellent airtightness. Yet another objective of this invention is to provide a cover seal application method capable of achieving excellent airtightness.

The present description provides an electronic device comprising a housing that forms an internal space to house components, and a cover seal. The housing has an opening and/or gap through which gases can move between the inside (internal space) and outside of the housing. The cover seal is bonded to the housing, covering the opening and/or gap. The cover seal is formed of at least one PSA sheet having a gas barrier layer and a PSA layer provided at least on one face of the gas barrier layer. The bonding interface between the housing and the cover seal has, along the bonding interface, a first bonding area, a non-bonding area and a second bonding area in this order from the opening and/or gap towards the outside.

In the electronic device having this constitution, in an in-plane direction of the bonding interface between the PSA layer and adherend, even if the filler gas (e.g. helium gas) passes through the first bonding area and leaks out towards the opening and/or gap, the leaked gas temporarily stays in a void space (typically an enclosed space) formed at the non-bonding area present in the bonding interface. The concentration of leaked gas in this space is significantly lower than that in the internal space of the housing. Part of the less concentrated gas then flows from the void space at the non-bonding area (i.e. the non-bonding void space) through the second bonding area and further leaks to the outside. In this flow, the gas leaks to the outside comes from the non-bonding void space at a low concentration. As a result, the final amount of leaked gas decreases as compare to an embodiment not having the non-bonding area. This effect is obtained also when preventing permeation of gases and water (typically water vapor or moisture) from the outside to the inside (internal space) of an electronic device. According to this embodiment, the internal space of the housing has excellent airtightness.

In a preferable embodiment of the art disclosed herein (including the electronic device, cover seal and its application method), an enclosed space is formed between an outer edge of the PSA layer and the opening and/or gap. The airtightness-enhancing effect is preferably obtained with the presence of the enclosed space between the PSA layer's outer edge and the opening and/or gap.

In a preferable embodiment of the art disclosed herein, the cover seal comprises a first PSA sheet covering the opening and/or gap as well as a second PSA sheet covering at least the outer edge of the first PSA sheet. An enclosed space is formed adjacent to where the outer edge of the first PSA sheet and the second PSA sheet overlap. According to this embodiment, without devising structures of PSA sheets or a structure of adherend (e.g. a housing), several PSA sheets can be simply applied in layers to form a non-bonding area (and even an enclosed space) between the first and second bonding areas in the bonding interface. This can bring about airtightness more easily.

When several PSA sheets are used to seal one internal space, needless to say, the number of PSA sheets is not limited to two and it can be three or more. The second PSA sheet may be applied after the first PSA sheet is applied. Alternatively, the first and second PSA sheets layered in advance can be applied to an adherend.

In a preferable embodiment of the art disclosed herein, the second PSA sheet entirely covers the first PSA sheet bonded to the housing. According to this embodiment, just by overlaying the second PSA sheet to entirely cover the first PSA sheet, a non-bonding area (and even an enclosed space) can be formed between the first and second bonding areas in the bonding interface.

In a preferable embodiment of the art disclosed herein, of the two faces of the cover seal, in the face on which the PSA layer is formed, a circular groove is formed, wherein the groove is recessed towards the reverse face and is arranged circularly when viewed in the thickness direction (i.e. in this embodiment, the adhesive face (the face on which the PSA layer is formed) has a circular groove. or, the cover seal is formed an annular groove on the surface of the pressure-sensitive adhesive layer in a concave shape toward the opposite surface, the groove is arranged in an annular shape when viewed from the thickness direction.). When the cover seal is bonded to a housing, the circular groove forms a non-bonding area, creating a void space; and this highly prevents permeation of gases and water.

When a circular groove is formed in the cover seal, needless to say, the number of circular grooves is not limited to one. The circular groove can be arranged circularly connected (unbroken) when viewed in the thickness direction (The circular groove can be connected (unbroken)). In this case, the housings opening or gap is located inside the circularly connected void space; and therefore, the airtightness is further enhanced. It is noted that the circular groove can be arranged circularly, yet intermittently (the groove can be in an intermittent (broken) circle).

In a preferable embodiment of the art disclosed herein, along the bonding interface between the housing and the cover seal, the first bonding area has a width from the opening and/or gap to the non-bonding area and the second bonding area has a width from the non-bonding area to the PSA layer's outer edge, with the first bonding area's width being larger than the second bonding area's width. This embodiment brings about a further decrease in concentration of leaked gas entrapped in the non-bonding void space as compared to an embodiment where the first bonding area's width is smaller than the second bonding area's width. This can bring about greater airtightness.

In another preferable embodiment, along the bonding interface between the housing and the cover seal, the first bonding area has a width from the opening and/or gap to the non-bonding area and the second bonding area has a width from the non-bonding area to the PSA layer's outer edge, with the first bonding area's width being smaller than the second bonding area's width. This embodiment can reduce the amount of gases and water entering from the outside as compared to an embodiment where the first bonding area's width is larger than the second bonding area's width. This can more highly prevent contamination of the internal space with external impurities.

In a preferable embodiment of the art disclosed herein, the gas barrier layer has a moisture permeability below 5×10⁻¹ g/m², determined per 24 hours at 40° C. at 90% RH based on the MOCON method (JIS K7129:2008). The cover seal having such a gas barrier layer has not only gas barrier properties, but also excellent moisture impermeability.

The present description also provides a cover seal. The cover seal has at least one PSA sheet having a gas barrier layer and a PSA layer provided on at least one face of the gas barrier layer. The PSA layer has an adhesive face having a first bonding area, a non-bonding area and a second bonding area in this order along its surface. For instance, when bonded to a housing, the cover seal in this embodiment forms a non-bonding area between the PSA layer's outer edge and the housing's opening and/or gap. With the non-bonding void space formed between the first and second bonding areas, excellent airtightness is obtained.

As used herein, the term “cover seal” refers to a seal, sealing part, sealing supply and sealing material in general, which are applied to cover adherends at least partially; and it typically refers to a product that covers openings and gaps of housings of electronic devices to prevent the air from flowing in and out of the housings.

The cover seal disclosed herein has excellent airtightness. Thus, it is preferably used for sealing the internal space of an electronic device that requires airtightness and further requires moisture resistance as necessary.

The present description also provides a method for applying a cover seal to a housing that forms an internal space to house components so as to seal the internal space. The method includes a step of applying a cover seal to cover an opening and/or gap of the housing. In the application step, the cover seal is applied so that the bonding interface between the housing and the cover seal has a first bonding area, a non-bonding area and a second bonding area from the opening and/or gap towards the outside along the bonding interface. According to such a method, it is possible to obtain an object (e.g. an electronic device) having a housing with a highly airtight internal space.

In a preferable embodiment, the application method includes (A) a step of applying the first PSA sheet so as to cover the opening and/or gap; and (B) a step of applying the second PSA sheet to cover at least an outer edge of the first PSA sheet to form an enclosed space adjacent to where the outer edge of the first PSA sheet and the second PSA sheet overlap. According to such a method, without devising a cover seal structure or a structure of adherend (e.g. a housing), several PSA sheets can be simply applied in layers to form an enclosed space. Thus, airtightness can be obtained more easily.

### BRIEF DESCRIPTION OF THE DRAWINGS

FIG. 1 shows a cross-sectional diagram schematically illustrating the magnetic disc device according to an embodiment.

FIG. 2 shows an enlarged cross-sectional diagram schematically illustrating part of the magnetic disc device according to an embodiment.

FIG. 3 shows a cross-sectional diagram schematically illustrating the magnetic disc device according to another embodiment.

FIG. 4 shows an enlarged cross-sectional diagram schematically illustrating part of the magnetic disc device according to another embodiment.

FIG. 5 shows a cross-sectional diagram schematically illustrating an example of constitution of the PSA sheet.

FIG. 6 shows a schematic diagram of a test equipment used in empirical testing.

FIG. 7 shows a schematic diagram of a test sample used in empirical testing.

FIG. 8 shows a schematic diagram illustrating the method for determining the moisture permeability.

FIG. 9 shows an enlarged top view of a sample used in determining the moisture permeability.

### DETAILED DESCRIPTION OF THE INVENTION

Preferable embodiments of the present invention are described below. Matters necessary to practice this invention other than those specifically referred to in this description can be understood by a person skilled in the art based on the disclosure about implementing the invention in this description and common technical knowledge at the time the application was filed. The present invention can be practiced based on the contents disclosed in this description and common technical knowledge in the subject field. In the drawings referenced below, a common reference numeral may be assigned to members or sites producing the same effects, and redundant descriptions are sometimes omitted or simplified. The embodiments described in the drawings are schematized for clear illustration of the present invention, and do not necessarily represent the accurate size or reduction scale of an actual product of the PSA sheet or magnetic disc device of this invention.

As used herein, the term “PSA” refers to, as described earlier, a material that exists as a soft solid (a viscoelastic material) in a room temperature range and has a property to adhere easily to an adherend with some pressure applied. As defined in “Adhesion: Fundamental and Practice” by C. A. Dahlquist (McLaren & Sons (1966), P. 143), in general, PSA referred to herein can be a material that has a property satisfying complex tensile modulus E*(1 Hz)<10⁷ dyne/cm² (typically, a material that exhibits the described characteristics at 25° C.).

The concept of PSA sheet herein may encompass so-called PSA tape, PSA labels, PSA film, etc. The PSA sheet disclosed herein can be in a roll or in a flat sheet. Alternatively, the PSA sheet may be processed into various shapes.

### <Electronic Device>

The type of electronic device disclosed herein is not particularly limited. The art disclosed herein can be applied to various types of electronic devices. The art disclosed herein is preferably applied to an electronic device whose internal space needs to be airtight as well as to an electronic device with which entering of contamination such as water are undesirable. In particular, it is particularly preferably applied to an electronic device that requires airtightness and moisture resistance. Typical examples include a magnetic disc device such as HDD. In a magnetic disc device, for instance, contamination by a gas (e.g. siloxane gas) may cause failure of the device; and therefore, it is important to prevent such gas contamination. In a magnetic disc device employing HAMR, it is important to prevent water entrance which badly affects the life for writing. The art disclosed herein is preferably applied to such an HAMR magnetic disc device. The PSA sheet disclosed herein can be used to seal internal spaces of other electronic devices besides magnetic disc devices. For instance, the art disclosed herein can also be applied to seal the internal space of an organic light-emitting diode.

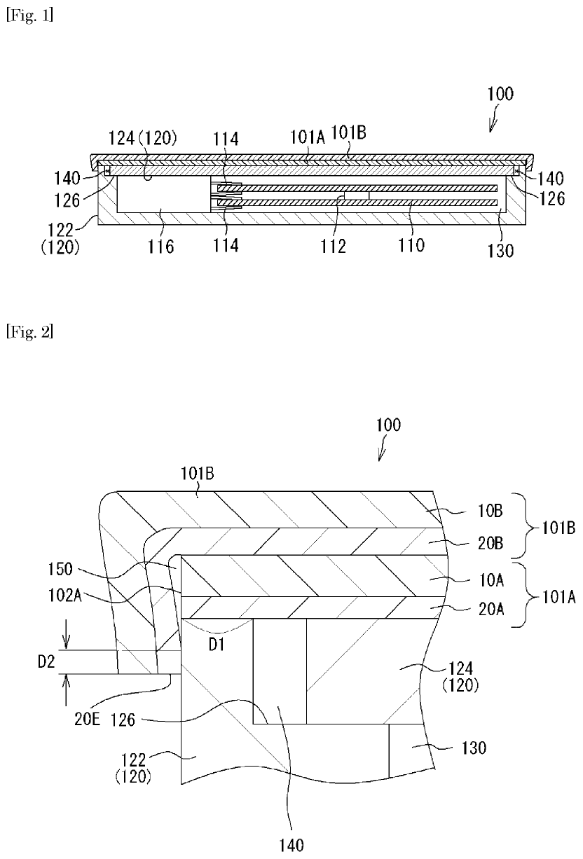

FIG. 1 and FIG. 2 show an embodiment of the magnetic disc device as a favorable example to which the art disclosed herein can be applied. FIG. 1 shows a cross-sectional diagram schematically illustrating the magnetic disc device according to an embodiment. FIG. 2 shows an enlarged cross-sectional diagram schematically illustrating part of the magnetic disc device according to an embodiment. A magnetic disc device 100 comprises a data-recording magnetic disc 110, a spindle motor 112 that rotates magnetic disc 110, a magnetic head 114 that reads and writes data on magnetic disc 110, and an actuator 116 that supplies power to magnetic head 114. Actuator 116 has a built-in linear motor not shown in the drawing. In this example of constitution, two magnetic discs 110 are included, but it is not limited to this and three or more magnetic discs may be included.

These components of magnetic disc device 100 are placed in a housing 120 which serves as a casing for magnetic disc device 100. Housing 120 forms an internal space 130 that houses the components. In particular, the components of magnetic disc device 100 are contained in a box-shaped housing base member (a support structure) 122 having a top opening and the top opening of housing base member 122 is covered with a rigid cover member 124. More specifically, the top opening of housing base member 122 has a recessed portion around the inner circumference and the outer rim of cover member 124 is placed on the bottom of recessed portion 126, with cover member 124 covering the opening.

Cover seal 101 seals an opening and/or gap 140 through which gases can move between internal space 130 (the inside) and outside of housing 120, to completely seal internal space 130. In this embodiment, cover member 124 is placed at the bottom of a recess 126 to close internal space 30; however, gases can slightly move through the interface (contact area) between recess 126 and cover member 124. As a result, in this embodiment, the gap between housing base member 122 and cover member 124 corresponds to opening and/or gap 140.

In this embodiment, cover seal 101 comprises first and second PSA sheets 101A and 101B. First PSA sheet 101A has a gas barrier layer 10A and a PSA layer 20A. Second PSA sheet 101B has a gas barrier layer 10B and a PSA layer 20B. PSA sheet 101A is applied over cover member 124 to hide both cover member 124 and the top face (outer circumference of the opening) of housing base member 122, that is, the entire top face of housing 120. Here, the PSA layer 20A side of PSA sheet 101A is placed on the top face of housing 120. By this, PSA sheet 101A covers gap 140. PSA sheet 101A thereby maintains the interior of the device airtight. In addition, PSA sheet 101B covers at least the outer edge (edge face) 102A of PSA sheet 101A (see FIG. 2). Here, the PSA layer 20B side of PSA sheet 101B is placed on the PSA sheet 101A. In this embodiment, for example, PSA sheet 101B entirely covers PSA sheet 101A bonded to housing 120, thereby covering outer edge 102A of PSA sheet 101A. Enclosed space (non-bonding area) 150 is formed adjacent to where outer edge 102A of PSA sheet 101A and PSA sheet 101 overlap. By this, even if a filler gas (e.g. a low-density gas such as helium) in the internal space 130 leaks from the gap 140 towards the outside, the leaked gas is temporarily entrapped in the enclosed space 150 formed at the non-bonding area. The concentration of leaked gas entrapped in enclosed space 150 is lower than that in internal space 130. Thus, the amount of gas that further leaks out of enclosed space 150 will decrease.

As shown in FIG. 2, between PSA layers 20A and 20B, it is desirable that the width of first bonding area D1 from enclosed space 150 to the gap is larger than the width of second bonding area D2 from enclosed space 150 to the outer edge 20E of PSA layers 20A or 20B. In this embodiment, for example, in PSA layer 20A, the width of first bonding area D1 from enclosed space 150 to gap 140 is larger than the width of second bonding area D2 from enclosed space 150 to outer edge 20E of PSA layer 20B. This decreases the concentration of leaked gas entrapped in enclosed space 150.

In this embodiment, the width of the opening's rim (frame-shaped surface) at the top face of housing base member 122 (i.e. the distance from the openings perimeter at the top face of housing base member 122 to the peripheral side of the top face) can be about 0.1 mm to 5 mm (e.g. 3 mm or less, or even 2 mm or less) at the narrowest part. When PSA sheet 101A is applied as a cover seal to the top face of housing base member 122, the openings rim at the top face of housing base member 122 serves as the bonding interface with PSA sheet 101A and separates the inside (internal space) of magnetic disc device 100 from outside.

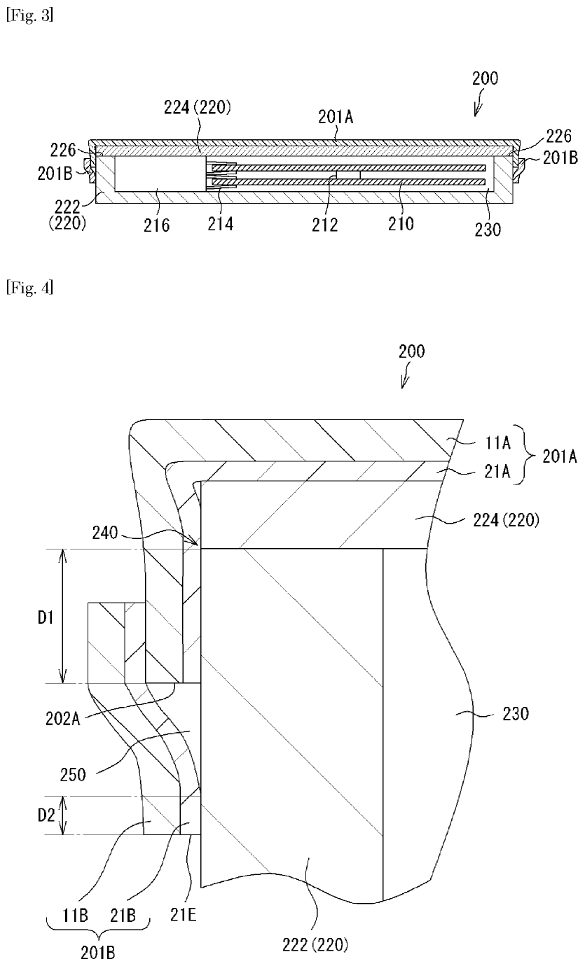

FIG. 3 and FIG. 4 show another embodiment of the magnetic disc device to which the art disclosed herein can be applied. A magnetic disc device 200 has basically the same constitution as the embodiment described above except for the structures of a housing 220 and a cover seal 201 (first and second PSA sheets 201A and 201B); and therefore, different features will be described. In this embodiment, housing 220 forms an internal space 230 to house components. In particular, components of magnetic disc device 200 are housed in a box-shaped housing base member (support structure) 222 having a top opening. The top opening of housing base member 222 is covered with a rigid cover member 224. More specifically, on the top rim (top edge of the lateral surface) of housing base member 222, the outer circumference of cover member 224 is placed to cover the opening. However, gases may slightly move through the interface (contact area) between the top rim of housing base member 222 and cover member 224. In other words, the interface between the top rim of housing base member 222 and cover member 224 may serve as a gap 240 through which gases can move between internal space 230 (the inside) and outside of housing 220 (see FIG. 4).

Cover seal 201 comprises first and second PSA sheets 201A and 201B. First PSA sheet 201A has a gas barrier layer 11A and a PSA layer 21A. The second PSA sheet 101B has a gas barrier layer 11B and a PSA layer 21B. In magnetic disc device 200, PSA sheet 201A covers cover member 224 and the top face (outer circumference of the opening) of housing base member 222 altogether, having a margin (or an extending portion) that further extends to the side of housing 220. In particular, the extending portion is bent from the top face over the corner of top rim to the side of housing base member 222. For example, such an extending portion is provided entirely to each side of the top periphery of housing 220. In other words, in magnetic disc device 200, PSA sheet 201A is applied to the top face and the upper lateral surface of housing 220. PSA sheet 201A covers gap 240 between housing base member 222 and cover member 224. In addition, PSA sheet 201A is applied so that it extends to the lateral surface of housing base member 222 while sealing a hole or gap communicating with the interior of magnetic disc device 200. This extends the sealing in in-plane directions of the bonding interface. Thus, PSA sheet 201A separating the sort of gap and the outside has a longer bonding interface, thereby increasing the gas impermeability of bonding areas in cover seal 201. In this embodiment, PSA sheet 201A has a distance running from the top rim (top edge of the lateral surface) towards the bottom of the lateral surface of housing 220 (i.e. a length of PSA sheet 201A covering the lateral surface) of about 1 mm or greater (e.g. 2 mm or greater, or even 3 mm or greater).

PSA sheet 201B further covers at least an outer edge 202A of PSA sheet 201A (see FIG. 4). In this embodiment, for example, PSA sheet 201B covers edge 202A of PSA sheet 201A bonded to housing 220. In particular, edge 202A is covered with PSA sheet 201B in a long piece which is applied to circularly surround edge 202A of PSA sheet 201A on the lateral surface of housing base member 222. An enclosed space (non-bonding area) 250 is formed adjacent to where outer edge 202A of PSA sheet 201A with PSA sheet 201B overlap. This efficiently maintains internal space 230 of housing 220 airtight.

It is noted that as shown in FIG. 4, in this embodiment as well, between PSA layers 21A and 21B, it is also desirable that the width of the first bonding area from enclosed space 250 to gap 240 is larger than the width of the second bonding area from enclosed space 250 to the outer edge 21E of PSA layers 21A or 21B. In this embodiment, for example, in PSA layer 21A, the width of first bonding area D1 from enclosed space 250 to gap 240 (the gap between housing base member 222 and cover member 224) is larger than the width of second bonding area D2 from enclosed space 250 to outer edge 21E of PSA layer 21B. This decreases the concentration of leaked gas entrapped in enclosed space 250.

In these embodiments, cover members 124 and 224 cover magnetic discs 110 and 210 as well as actuators 116 and 216 altogether, respectively, in one piece. However, they are not limited to these. They may cover magnetic discs 110 and 210, actuators 116 and 216, and other components, separately; or they may not cover actuators 116 or 216 while covering magnetic discs 110 and 210. Even in these embodiments, by applying the PSA sheet over the cover member, the inside of the device can be made airtight. In a magnetic disc device having such an embodiment, the airtight properties are obtained with the thin PSA sheet, thereby achieving a thin sealing structure. This can increase the capacity for housing magnetic discs, bringing about a magnetic disc device having a higher density and a larger capacity.

The embodiment described above shows an example where two PSA sheets are used to seal one internal space. Needless to say, however, when using several PSA sheets, the number of PSA sheets is not limited to two and it can be three or more. The second PSA sheet can be applied after the first PSA sheet is applied to the adherend. Alternatively, the first and second PSA sheets layered in advance may be applied to the adherend.

In the embodiment described above, at least in the bonding interface with the adherend, the PSA layer of each PSA sheet is formed continuously on one entire face of the gas barrier layer, but it is not limited to this. For instance, of the two faces of the PSA sheet, in the face on which the PSA layer is formed, a circular groove can be formed so that the groove is recessed towards the reverse face and is arranged circularly when viewed in the thickness direction. In this case, when the PSA sheet is bonded to a housing, the circular groove may form an enclosed space (non-bonding area). In this case, the number of PSA sheets used to seal one internal space can be one, two or more.

Needless to say, when a circular groove is formed in the PSA sheet, the number of circular grooves is not limited to one. The circular groove can be arranged, in a circularly continuous (unbroken) manner when viewed in the thickness direction. In this case, an opening and/or gap is located inside the enclosed circularly continuous space; and therefore, the internal space has greater airtightness. It is noted that the circular groove can be arranged circularly, yet intermittently.

In this embodiment, for example, as shown in FIG. 1 and FIG. 2, PSA sheet 101A covers gap 140 between housing base member 122 and cover member 124. In addition, PSA sheet 101B covers at least outer edge 102A of PSA sheet 101A. For instance, however, PSA sheets 201A and 201B applied to housing 220 (see FIG. 3 and FIG. 4) can also be applied to housing 120 (see FIG. 1 and FIG. 2). In other words, PSA sheet 201A may cover both cover member 124 and the top face (outer circumference of the opening) of housing base member 122 and further have a margin (or an extending portion) that further extends to the lateral surface of housing 120. In addition, PSA sheet 201B may cover at least outer edge 202A of PSA sheet 201A applied to housing 120.

For example, the extending portion of PSA sheet 201A may be provided entirely or partially to each side of the top periphery of the housing. In other words, PSA sheet 201A may be applied at least partially in a C-shaped to the top face and lateral surface of housing 220 in magnetic disc device 200. In addition, PSA sheet 201B may cover at least outer edge 202A of PSA sheet 201A applied to housing 120.

In the example shown in FIG. 1 and FIG. 2, the entire top face of housing 120 is covered with PSA sheet 101A and the PSA sheet 101A is then entirely covered with PSA sheet 101B. However, the two PSA sheets 101A and 101B can be embodied differently. For instance, PSA sheet 101A may be formed in a circle to match the shape of opening and/or gap 140 which is circular in a planar view. In this case, PSA sheet 101B may entirely cover the circular PSA sheet 101A. PSA sheet 101B can also be formed in a circle.

In the example shown in FIG. 3 and FIG. 4, the entire top face of housing 220 is covered with PSA sheet 201A and outer edge 202A of PSA sheet 201A is then covered with a long PSA sheet 201B. However, the two PSA sheets 201A and 201B can be embodied differently. For instance, a long PSA sheet 201A (like a strip) may circularly (circumferentially) cover the upper lateral surface of housing 220 where gap 240 is located. In this case, PSA sheet 201B may entirely cover the top of housing 220 including PSA sheet 201A or may further circularly cover circular PSA sheet 201A.

A gasket may also be placed between housing base member 122 and cover member 124. In this case, for instance, the gasket may be placed between the bottom of recess 126 of housing base member 122 and the end of outer circumference of cover member 124. A gasket can also be placed between housing base member 222 and cover member 224. In this case, for instance, the gasket may be placed between the top rim (top edge of the lateral surface) of housing base member 222 and the end of outer circumference of cover member 224.

For instance, a dehumidifying agent (e.g. silica gel, etc.) can be placed in at least any one of the following: enclosed spaces (non-bonding areas) 150, 250 and the gap between the housing base member and cover member. In this case, in the at least any one of enclosed spaces 150, 250 and the gap, the dehumidifying agent absorbs moisture to lower the humidity.

### <Cover Seal>

The cover seal disclosed herein is formed from at least one PSA sheet. Needless to say, the number of PSA sheets forming the cover seal is not particularly limited and it can be two, three or more. As described in the embodiments above, when it has the first and second PSA sheets, the second PSA sheet may extend outwards beyond the outer edge of the first PSA sheet to cover at least the outer edge of the first PSA sheet. The cover seal according to an embodiment is a laminate of the first and second PSA sheets, with the second PSA sheet entirely covering the first PSA sheet. In the cover seal according to another embodiment, the second PSA sheet is partially layered with the first PSA sheet to cover the outer edge of the first PSA sheet. While no particular limitations are imposed, the cover seal formed of a single PSA sheet may have, in the adhesive face of the PSA layer (in the PSA layer surface), a groove that will be a non-bonding area. The adhesive face of the PSA layer has, along the adhesive face, a first bonding area, a non-bonding area and a second bonding area in this order. Other features about the cover seal structure are as described above in regard to electronic devices. Thus, redundant descriptions are omitted.

### <Constitution of PSA Sheet>

The PSA sheet disclosed herein can be, for instance, an adhesively single-faced PSA sheet having a cross-sectional structure as shown in FIG. 5. A PSA sheet 1 comprises a gas barrier layer 10 and a PSA layer 20 supported on a first face of gas barrier layer 10. In particular, gas barrier layer 10 is a layered body (laminate film) in which a first resin layer 12, an inorganic layer 14 and a second resin layer 16 are layered in this order. The first resin layer 12 placed on the first face side of inorganic layer 14 forms an outer surface of PSA sheet 1 while the second resin layer 16 is placed on the second face side of inorganic layer 14, that is, the PSA layer 20 side. For example, from the standpoint of the airtightness, PSA layer 20 is formed continuously over the entire first face of gas barrier layer 10 at least in the area that bonds to an adherend. PSA sheet 1 prior to use (before applied to the adherend) may be protected with a release liner (not shown in the drawing) having a release face at least on the PSA layer 20 side surface.

### <Properties of PSA Sheet>

While no particular limitations are imposed, the PSA sheet disclosed herein suitably has a moisture permeability below 90 μg/cm² in an in-plane direction of bonding area of PSA sheet when determined per 24 hours at a permeation distance of 2.5 mm based on the MOCON method (equal-pressure method). Because of this, moisture permeation is limited in the in-plane direction of bonding area (vertical to the thickness direction of the PSA sheet) and excellent moisture resistance tends to be obtained. The moisture permeability in the in-plane direction of bonding area is preferably below 60 μg/cm², more preferably below 30 μm/cm², or yet more preferably below 15 μg/cm² (e.g. below 9 μg/cm²).

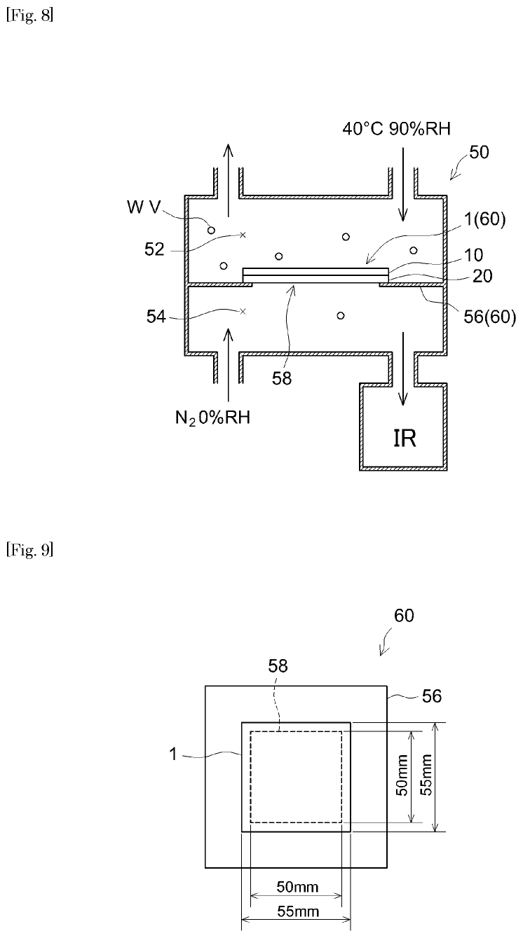

In particular, the through-bonding-plane moisture permeability is determined by the method described below.
(1) A metal plate having a 50 mm square opening at the center is obtained. FIG. 8 outlines a moisture permeability tester 50 used for determining the moisture permeability. In FIG. 8, reference number 56 shows the metal plate and reference number 58 shows the opening made in metal plate 56. FIG. 9 shows a top view of metal plate 56 having opening 58.
(2) The PSA sheet subject to measurement is cut to a 55 mm square and applied to cover the opening in the metal plate to prepare a measurement sample. The PSA sheet is applied to the metal plate over a bonded width of 2.5 mm at each side of the opening. The PSA sheet is applied by rolling a 2 kg roller back and forth once. The bonded width of the PSA sheet at each side of the opening is the width of the band of bonding area between the PSA sheet and the metal plate, indicating the permeation distance (mm) in the in-plane direction of bonding area of the PSA sheet. The circumference of the opening in the metal plate is referred to as the bonded length (mm). The bonded length (mm) is the total length of the band of bonding area exposed to water vapor. In particular, the measurement sample has a structure shown by reference number 60, formed of metal plate 56 and PSA sheet 1 applied to metal plate 56 as shown in FIG. 9.
(3) Based on Method B of JIS K 7129:2008, the measurement sample is placed between a dry chamber and a wet chamber in the moisture permeability tester. In particular, as shown in FIG. 8, a measurement sample 60 is positioned between a dry chamber 54 and a wet chamber 52. In FIG. 8, WV represents water vapor.
(4) Based on the MOCON method (equal-pressure method), conditioning is carried out for 3 hours. Subsequently, as shown in FIG. 8, at 40° C. and 90% RH (relative humidity), the amount (μg) of moisture that has permeated in the in-plane direction of bonding area of PSA sheet per one hour is determined.
(5) To obtain the through-bonding-plane moisture permeability (μg/cm²), the amount of permeated moisture per 24 hours converted from the measurement value and the PSA layer's surface area (permeation distance×bonded length) are substituted into the equation:

Moisture permeability (μg/cm²)=amount of permeated moisture (μg)/(permeation distance (cm)×bonded length (cm))

As used herein, the “24-hour through-bonding-plane moisture permeability (μg/cm²) determined at a permeation distance of 2.5 mm based on the MOCON method (equal-pressure method)” can be a value obtained by a measurement per 24 hours, but it is not limited to this; as described above, it can be a 24-hour value converted from a measurement taken for a certain time period (e.g. one hour). The measurement time can be longer than one hour (preferably about 6 hours) and the value per 24 hours converted from this measurement value can be used as well.

The kind of metal plate is not particularly limited. For instance, an aluminum plate can be used. The size of the metal plate is not particularly limited, either. In accordance with the tester size, etc., for instance, a 100 mm square plate can be used. It is suitable to use a metal plate having a smooth surface, for instance, one having a mean arithmetic roughness Ra of about 3 μm or less. As the tester, product name PERMATRAN-W3/34G available from MOCON, Inc. or a comparable product can be used. In a tester of this type, N₂ gas at 90% RH can be supplied to the wet chamber and N₂ gas at 0% RH can be supplied to the dry chamber. This maintains the two chambers divided by the measurement sample at an equal pressure. In the tester, the water vapor concentration is measured by an infrared sensor (indicated as “IR” in FIG. 8), but the means of detection is not limited to this. The position of the measurement sample in the tester is not particularly limited. The adhesive face of the PSA sheet can be placed either on the wet chamber side or on the dry chamber side.

While no particular limitations are imposed, the PSA sheet disclosed herein suitably has an amount of thermally released gas of 10 μg/cm² or less (in particular, 0 to 10 μg/cm²) when determined at 130° C. for 30 minutes by GC-MS. The PSA sheet with such highly-limited thermal gas release can be preferably used in an application (typically a magnetic disc device) for which the presence of volatile gas is undesirable. When the PSA sheet satisfying this property is used as a sealing material for a magnetic disc device, it can highly inhibit internal contamination with siloxane and other gas that affect the device. The amount of thermally released gas is preferably 7 μg/cm² or less, more preferably 5 μg/cm² or less, yet more preferably 3 μg/cm² or less, or particularly preferably 1 μg/cm² or less.

The amount of thermally released gas is determined based on the dynamic headspace method. In particular, a PSA sheet subject to measurement is cut out to a 7 cm² size to obtain a measurement sample. The measurement sample is sealed in a 50 mL vial and heated at 130° C. for 30 minutes, using a headspace autosampler. As the headspace autosampler, a commercial product can be used without particular limitations. For instance, product name EQ-12031HSA available from JEOL Ltd., or a comparable product can be used. The total amount of gas released from the measurement sample is determined by gas chromatography/mass spectrometry (GC-MS). A commercial GC-MS can be used. The amount of thermally released gas is the amount of gas released per unit surface area of PSA sheet (in μg/cm²).

While no particular limitations are imposed, the PSA sheet disclosed herein has a 180° peel strength to stainless steel (an adhesive strength) of suitably 1 N/20 mm or greater, or preferably 3 N/20 mm or greater, when determined based on JIS Z 0237:2009. Having such an adhesive strength, the PSA sheet can bond well to an adherend to provide good sealing. The adhesive strength is more preferably 5 N/20 mm or greater, yet more preferably 8 N/20 mm or greater, or particularly preferably 10 N/20 mm or greater (e.g. 12 N/20 mm or greater). The maximum adhesive strength is not particularly limited. From the standpoint of preventing left-over adhesive residue, it is suitably about 20 N/20 mm or less (e.g. about 15 N/20 mm or less).

The adhesive strength of a PSA sheet is determined by the following method: A PSA sheet subject to measurement is cut to a 20 mm wide, 100 mm long size to prepare a test piece. In an environment at 23° C. and 50% RH, the adhesive face of the test piece is press-bonded to a stainless steel plate (SUS304BA plate) to obtain a measurement sample. The press-bonding is carried out by rolling a 2 kg roller back and forth once. The measurement sample is left standing in an environment at 23° C. and 50% RH for 30 minutes. Subsequently, using a tensile tester, based on JIS Z 0237:2009, the peel strength (N/20 mm) is determined at a tensile speed of 300 mm/min at a peel angle of 180°. As the tensile tester, Precision Universal Tensile Tester Autograph AG-IS 50N available from Shimadzu Corporation or a comparable product can be used.

The PSA sheet disclosed herein preferably shows a displacement less than 2 mm in a shear holding power test carried out with a 1 kg load at 60° C. for one hour. The PSA sheet satisfying this property may show good holding power even when used at a relatively high temperature. The displacement in the shear holding power test is more preferably less than 1 mm, or yet more preferably less than 0.7 mm (e.g. less than 0.5 mm, or even less than 0.1 mm). The PSA sheet according to a particularly preferable embodiment shows no displacement (i.e. a displacement of about 0 mm) in the shear holding power test.

The shear holding power of a PSA sheet is determined by the following method: In particular, the PSA sheet subject to measurement is cut 10 mm wide, 20 mm long to prepare a test piece. In an environment at 23° C. and 50% RH, the adhesive face of the test piece is press-bonded to a stainless steel plate to obtain a measurement sample. The press-bonding is carried out by rolling a 2 kg roller back and forth once. The measurement sample is vertically suspended and left in an environment at 60° C. and 50% RH for 30 minutes. Subsequently, a 1 kg weight is attached to the free lower end of the test piece to start the test. The test is carried out for one hour and the distance that the test piece displaced (the displacement) is measured at one hour. The same measurement method is employed in the working examples described later.

The PSA sheet disclosed herein preferably has a tensile modulus per unit width in a prescribed range. In particular, the tensile modulus is preferably greater than 1000 N/cm, more preferably greater than 1400 N/cm, yet more preferably greater than 1800 N/cm, or particularly preferably greater than 2200 N/cm. The PSA sheet having such a tensile modulus has suitable rigidity and is less susceptible to creasing. It tends to provide excellent handling properties as well. The tensile modulus is preferably less than 3500 N/cm, more preferably less than 3000 N/cm, or yet more preferably less than 2800 N/cm (e.g. less than 2600 N/cm). The PSA sheet having such a tensile modulus has good adherend conformability and can well conform in a bent state to an area of the adherend including a corner.

The tensile modulus per unit width of PSA sheet is determined as follows: In particular, the PSA sheet is cut to a 10 mm wide, 50 mm long strip to prepare a test piece. The two ends of the length of the test piece are clamped with chucks in a tensile tester. In an atmosphere at 23° C., at an inter-chuck distance of 20 mm, at a speed of 50 mm/min, a tensile test is conducted using the tensile tester to obtain a stress-strain curve. Based on the initial slope of the resulting stress-strain curve, the Young's modulus (N/mm²=MPa) is determined by linear regression of the curve between two specified strain points ε1 and ε2. From the product of the resulting value and the thickness of the PSA sheet, the tensile modulus per unit width (N/cm) can be determined. As the tensile tester, a commonly known or conventionally used product can be used. For instance, AUTOGRAPH AG-IS available from Shimadzu Corporation or a comparable product can be used.

The total thickness of the PSA sheet disclosed herein is not particularly limited. It is suitably about 6 μm or greater. From the standpoint of the airtightness and crease resistance, etc., it is preferably 25 μm or greater, more preferably 40 μm or greater, or yet more preferably 60 μm or greater. The total thickness is suitably about 1.2 mm or less. From the standpoint of the adherend conformability and of reducing the thickness and weight, it is preferably 200 μm or less, more preferably 150 μm or less, or yet more preferably 120 μm or less (e.g. less than 100 μm). The total thickness of a PSA sheet here refers to the combined thickness of the gas barrier layer and the PSA layer, not including the thickness of the release liner described later.

### <PSA Layer>

### (Base Polymer)

In the art disclosed herein, the type of PSA forming the PSA layer is not particularly limited. The PSA may comprise, as its base polymer, one, two or more species of various rubberlike polymers such as rubber-based polymers, acrylic polymers, polyester-based polymers, urethane-based polymers, polyether-based polymers, silicone-based polymers, polyamide-based polymer and fluorine-based polymers that are known in the PSA field. From the standpoint of the moisture resistance and reduction of outgassing, it is preferable to use a rubber-based PSA comprising a rubber-based polymer as the base polymer or a PSA comprising an acrylic polymer as the base polymer. Other examples include a PSA comprising a rubber based polymer and an acrylic polymer as the base polymer. In particular, a highly moisture-resistant rubber-based PSA layer is more preferable. When the PSA sheet disclosed herein is used in a magnetic disc device, it is desirable that the PSA is essentially free of a silicone-based polymer which may form siloxane gas.

The PSA sheet having a rubber-based PSA layer and the PSA sheet having an acrylic PSA layer are primarily discussed below; however, the PSA layer of the PSA sheet disclosed herein is not limited to layers formed of rubber based PSA and acrylic PSA.

The “base polymer” of PSA refers to the primary component among rubber-like polymers (polymers that exhibit rubber elasticity in a near-room temperature range) (i.e. a component accounting for more than 50% by weight of the rubberlike polymers) in the PSA.

### (Rubber-Based Polymer)

The PSA layer disclosed herein is preferably a rubber-based PSA layer formed from a PSA composition whose base polymer is a rubber-based polymer. Examples of the base polymer include various rubber-based polymers such as natural rubber; styrene-butadiene rubber (SBR); polyisoprene; a butene-based polymer comprising butene (referring to 1-butene as well as cis- or trans-2-butene) and/or 2-methylpropene (isobutylene) as the primary monomer(s); A-B-A block copolymer rubber and a hydrogenation product thereof, for instance, styrene-butadiene-styrene block copolymer rubber (SBS), styrene-isoprene-styrene block copolymer rubber (SIS), styrene-isobutylene-styrene block copolymer rubber (SIBS), styrene-vinyl isoprene-styrene block copolymer rubber (SVIS), styrene-ethylene-butylene-styrene block copolymer rubber (SEBS) which is a hydrogenation product of SBS, styrene-ethylene-propylene-styrene block copolymer rubber (SEPS) which is a hydrogenation product of SIS, and styrene-isoprene-propylene-styrene block copolymer (SIPS). Among these rubber-based polymers, solely one species or a combination of two or more species can be used. Favorable examples of the butene-based polymer include isobutylene-based polymers. Isobutylene-based polymers are highly hydrophobic due to their molecular structures. Thus, a PSA layer (isobutylene-based PSA layer) comprising an isobutylene-based polymer as the base polymer may have relatively low moisture permeability on its own. This is advantageous from the standpoint of preventing water vapor from permeating through the lateral surface of the PSA layer at an edges face of the PSA sheet. Such a PSA layer tends to have a good elastic modulus as well as excellent removability. Specific examples of the isobutylene-based polymer include polyisobutylene and isobutylene-isoprene copolymer (butyl rubber).

The starting monomer mixture to form the rubber-based polymer disclosed herein include one, two or more species of monomers selected among butene, isobutylene, isoprene, butadiene, styrene, ethylene and propylene. The rubber-based polymer is obtainable by polymerizing one, two or more species among the monomers exemplified above. In the starting monomer mixture to form the rubber-based polymer disclosed herein, the one, two or more species of monomers typically account for 50% or more by weight (e.g. 50% to 100% by weight), preferably 75% or more by weight, more preferably 85% or more by weight, or yet more preferably 90% or more by weight (e.g. 95% by weight or more). The ratio of these monomers in the entire starting monomer mixture can be 99% by weight or higher. The rubber-based polymer according to a preferable embodiment is obtainable by polymerizing one, two or more species of monomers selected among isobutylene, isoprene and butene. From the standpoint of reduction of outgassing, the styrene content in the starting monomer mixture is preferably less than 10% by weight or more preferably less than 1% by weight. The art disclosed herein can be preferably implemented in an embodiment where the starting monomer mixture is essentially free of styrene.

In a preferable embodiment of the PSA sheet disclosed herein, the isobutylene-based polymer accounts for more than 50% by weight (e.g. 70% by weight or more, or even 85% by weight or more) of the polymers in the PSA. The PSA may be essentially free of other polymers besides the isobutylene-based polymer. In such a PSA, for instance, the ratio of non-isobutylene-based polymer in the starting monomer mixture can be 1% by weight or lower or even below the detection limit.

As used herein, the term “isobutylene-based polymer” is not limited to isobutylene homopolymer (homopolyisobutylene), and also encompasses a copolymer whose primary monomer is isobutylene (a copolymer primarily formed of isobutylene). The copolymer includes a copolymer in which isobutylene accounts for the highest ratio among the monomers forming the isobutylene-based polymer. In a typical copolymer, isobutylene may account for more than 50% by weight of the monomers, or even 70% by weight or more. Examples of the copolymer include a copolymer of isobutylene and butene (normal butylene), a copolymer (butyl rubber) of isobutylene and isoprene, vulcanized products and modified products of these. Examples of the copolymers include butyl rubbers such as regular butyl rubber, chlorinated butyl rubber, brominated butyl rubber, and partially crosslinked butyl rubber. Examples of the vulcanized and modified products include those modified with functional groups such as hydroxy group, carboxy group, amino group, and epoxy group. The isobutylene-based polymer that can be preferably used from the standpoint of the airtightness, moisture resistance, reduction of outgassing, and adhesive strength, etc., includes polyisobutylene and isobutylene-isoprene copolymer (butyl rubber). The copolymer can be, for instance, a copolymer (e.g. an isobutylene-isoprene copolymer) of which the other monomers (isoprene, etc.) excluding isobutylene has a copolymerization ratio lower than 30% by mol.

As used herein, the “polyisobutylene” refers to a polyisobutylene in which the copolymerization ratio of monomers excluding isobutylene is 10% or lower (preferably 5% or lower) by weight. In particular, homopolyisobutylene is preferable.

The molecular weight of the isobutylene-based polymer is not particularly limited. For instance, a species having a weight average molecular weight (Mw) of about 5×10⁴ or higher (preferably about 15×10⁴ or higher, e.g. about 30×10⁴ or higher) can be suitably selected and used. The maximum Mw is not particularly limited and can be about 150×10⁴ or lower (preferably about 100×10⁴ or lower, e.g. about 80×10⁴ or lower). Several different isobutylene-based polymers varying in Mw can be used together. Having a Mw in these ranges, the PSA can be easily adjusted to have an elasticity in a preferable range and is likely to show good cohesive strength.

The molecular weight of the polyisobutylene is not particularly limited. For instance, a species having a Mw of about 1×10⁴ or higher can be suitably selected and used. The maximum Mw is not particularly limited and can be about 150×10⁴ or lower. From the standpoint of the airtightness and moisture resistance, the polyisobutylene according to a preferable embodiment has a Mw of preferably about 100×10⁴ or lower, for instance, about 80×10⁴ or lower. From the standpoint of the PSA's elastic modulus, cohesive strength and so on, the Mw is preferably about 2×10⁴ or higher, more preferably about 3×10⁴ or higher, or yet more preferably about 5×10⁴ or higher (e.g. about 7×10⁴ or higher). From the standpoint of the airtightness and moisture resistance, the Mw is preferably about 50×10⁴ or lower, more preferably about 30×10⁴ or lower, yet more preferably about 15×10⁴ or lower, or particularly preferably about 10×10⁴ or lower (e.g. below 10×10⁴). The polyisobutylene according to another embodiment may have a Mw of, for instance, about 5×10⁴ or higher, or preferably about 15×10⁴ or higher (typically about 30×10⁴ or higher).

While no particular limitations are imposed, as the polyisobutylene, it is preferable to use a species having a dispersity (Mw/Mn) (which is indicated as a ratio of weight average molecular weight (Mw) to number average molecular weight (Mn)) in a range of 3 to 7 (more preferably 3 to 6, e.g. 3.5 to 5.5). Several species of polyisobutylene varying in Mw/Mn can be used together.

The Mw and Mn values of an isobutylene-based polymer here refer to values based on polystyrene that are determined by gel permeation chromatography (GPC) analysis. As the GPC analyzer, for instance, model name HLC-8120 GPC available from Tosoh Corporation can be used.

The molecular weight of the butyl rubber is not particularly limited. For instance, a species having a Mw in a range between 5×10⁴ and 100×10⁴ can be suitably selected and used. In view of the balance between the PSA layer's ease of formation and tight adhesiveness (adhesive strength) to adherend, the butyl rubber has a Mw of preferably 10×10⁴ or higher, or more preferably 15×10⁴ or higher; and preferably 100×10⁴ or lower, or more preferably 80×10⁴ or lower. Several species of butyl rubber varying in Mw can be used together.

While no particular limitations are imposed, the butyl rubber has a dispersity (Mw/Mn) in a range between 3 and 8 or more preferably in a range between 4 and 7. Several species of butyl rubber varying in Mw/Mn can be used together. The butyl rubber's Mw and Mn can be determined by the same GPC analysis as the polyisobutylene.

The Mooney viscosity of the butyl rubber is not particularly limited. For instance, a butyl rubber having a Mooney viscosity ML₁₊₈(125° C.) between 10 and 100 can be used. In view of the balance between the PSA layer's ease of formation and tightness of bonding to adherend (adhesive strength), a butyl rubber having a Mooney viscosity ML₁₊₈(125° C.) of 15 to 80 (more preferably 30 to 70, e.g. 40 to 60) is preferable.

In a preferable embodiment of the art disclosed herein, the PSA layer comprises a rubber based polymer A and a rubber based polymer B as its base polymers. The rubber-based polymers A and B are preferably both isobutylene-based polymers. The rubber based polymer A according to a more preferable embodiment is an isobutylene-based polymer in which isobutylene is polymerized at a ratio of at least 50% (e.g. at least 70%, preferably at least 80%, or yet more preferably at least 90%) by weight; it is typically polyisobutylene. The rubber-based polymer B is an isobutylene-based polymer in which isobutylene and isoprene are copolymerized (i.e. an isobutylene-based copolymer); it is typically an isobutylene-isoprene copolymer. In the copolymer, the combined amount of isobutylene and isoprene as monomers accounts for typically at least 50% (e.g. at least 70%, preferably at least 80%, or yet more preferably at least 90%) by weight of the entire monomers. The use of rubber based polymers A and B can bring the PSA layer's elastic modulus in a preferable range, and superior airtightness and moisture resistance can be obtained.

In the embodiment using rubber based polymers A and B together, because they vary in molecular weight, it is possible to preferably bring about airtightness and moisture resistance based on the lower molecular polymer as well as adhesive properties (cohesive strength, etc.) based on the higher molecular weight polymer. From such a standpoint, in an embodiment in which the rubber based polymer A has a relatively higher molecular weight, the ratio (M_{A}/M_{B}) of rubber-based polymer A's Mw (M_{A}) to rubber-based polymer B's Mw (M_{B}) is higher than 1, preferably about 2 or higher, more preferably about 3 or higher, or yet more preferably about 5 or higher (e.g. about 7 or higher). The maximum M_{A}/M_{B} ratio value is suitably about 100 or lower, preferably about 50 or lower, more preferably about 20 or lower, or yet more preferably about 10 or lower (e.g. lower than 10). In an embodiment in which the rubber-based polymer B has a relatively higher molecular weight, the ratio (M_{B}/M_{A}) of rubber based polymer B's Mw (M_{B}) to rubber based polymer A's Mw (M_{A}) is higher than 1, preferably about 2 or higher, more preferably about 3 or higher, or yet more preferably about 5 or higher (e.g. about 7 or higher). The maximum M_{B}/M_{A} ratio value is suitably about 100 or lower, preferably about 50 or lower, more preferably about 20 or lower, or yet more preferably about 10 or lower (e.g. lower than 10).

In the embodiment using rubber based polymers A and B together, from the standpoint of combining airtightness and moisture resistance with adhesive properties based on their molecular weights, the rubber-based polymer A (e.g. polyisobutylene) has a Mw of suitably about 80×10⁴ or lower, preferably about 50×10⁴ or lower, more preferably about 30×10⁴ or lower, yet more preferably about 15×10⁴ or lower, or particularly preferably 10×10⁴ or lower (e.g. lower than 10×10⁴). The rubber-based polymer A has a Mw of suitably about 1×10⁴ or higher, preferably about 2×10⁴ or higher, more preferably about 3×10⁴ or higher, yet more preferably about 5×10⁴ or higher (e.g. about 7×10⁴ or higher). On the other hand, the rubber-based polymer B (e.g. isobutylene-isoprene copolymer) has a Mw of suitably about 5×10⁴ or higher, preferably 10×10⁴ or higher, more preferably 15×10⁴ or higher, or yet more preferably about 30×10⁴ or higher (e.g. 50×10⁴ or higher). The rubber-based polymer B has a Mw of suitably about 150×10⁴ or lower, preferably about 100×10⁴ or lower, more preferably about 80×10⁴ or lower, or yet more preferably about 70×10⁴ or lower (e.g. about 60×10⁴ or lower).

When rubber based polymers A and B are used, their blend ratio can be suitably selected so as to obtain preferable elastic modulus, airtightness, moisture resistance and adhesive properties disclosed herein. The weight ratio (P_{A}/P_{B}) of rubber-based polymer A (P_{A}) to rubber-based polymer B (P_{B}) can be, for instance, 95/5 to 5/95, preferably 90/10 to 10/90, more preferably 80/20 to 20/80, yet more preferably 70/30 to 30/70, or particularly preferably 60/40 to 40/60.

In a preferable embodiment, the dispersity (Mw/Mn) of the aforementioned base polymers at large is 3 or higher, or more preferably 4 or higher. According to the PSA comprising such base polymers, adhesive strength can be easily combined with resistance to leftover adhesive residue. It also brings the PSA layer's elastic modulus in a favorable range and good airtightness and moisture resistance tend to be obtained. At or above a certain Mw/Mn value, the PSA can be obtained with a low solution viscosity for its Mw. The dispersity of the base polymers at large can also be 5 or higher, 6 or higher, or even 7 or higher. The maximum dispersity of the base polymers at large is not particularly limited; it is preferably 10 or lower (e.g. 8 or lower).

The art disclosed herein can be preferably implemented in an embodiment having a PSA layer formed of a PSA (a non-crosslinked PSA) in which the based polymers are not crosslinked. Here, the term “PSA layer formed of a non-crosslinked PSA” refers to a PSA layer that has not been subjected to an intentional treatment (i.e. crosslinking treatment, e.g. addition of a crosslinking agent, etc.) for forming chemical bonds among the base polymers.

### (Acrylic Polymer)

In an embodiment of the art disclosed herein, the PSA layer is an acrylic PSA layer comprising an acrylic polymer as the base polymer. The acrylic polymer is preferably a polymer of a starting monomer mixture that comprises an alkyl (meth)acrylate as the primary monomer and may further comprise a secondary monomer copolymerizable with the primary monomer. Here, the primary monomer refers to a component accounting for more than 50% by weight of the starting monomer mixture.

As used herein, the term “(meth)acryloyl” comprehensively refers to acryloyl and methacryloyl. Similarly, the term “(meth)acrylate” comprehensively refers to acrylate and methacrylate, and the term “(meth)acryl” comprehensively refers to acryl and methacryl.

As the alkyl (meth)acrylate, for instance, a compound represented by the following formula (1) can preferably be used:

CH₂═C(R¹)COOR² (1)

Here, R¹ in the formula (1) is a hydrogen atom or a methyl group. R² is an acyclic alkyl group having 1 to 20 carbon atoms (hereinafter, such a range of the number of carbon atoms may be indicated as “C₁₋₂₀”). From the standpoint of the PSA's storage modulus, adhesive properties, etc., an alkyl (meth)acrylate in which R² is a C₁₋₁₈ acyclic alkyl group is preferable; an alkyl (meth)acrylate in which R² is a C₂₋₁₄ acyclic alkyl group is more preferable; an alkyl (meth)acrylate in which R² is a C₄₋₁₂ acyclic alkyl group is even more preferable. In particular, it is preferable to use an alkyl acrylate as the primary monomer. The acyclic alkyl group includes linear and branched alkyl groups.

Examples of the alkyl (meth)acrylate in which R² is an acyclic C₁₋₂₀ alkyl group include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. These alkyl (meth)acrylates can be used singly as one species or in a combination of two or more species.

From the standpoint of the moisture resistance, as the primary monomer forming the acrylic polymer, it is preferable to use an alkyl (meth)acrylate having a higher number of carbon atoms in the acyclic alkyl group. With increasing number of carbon atoms of side-chain alkyl group in the acrylic polymer, the polymer tends to have higher hydrophobicity and greater moisture resistance. The number of carbon atoms in the acyclic alkyl group is 2 or higher, preferably 4 or higher, more preferably 8 or higher, yet more preferably 9 or higher, or particularly preferably 12 or higher.

The ratio of alkyl (meth)acrylate as the primary monomer in all the monomers forming the acrylic polymer is preferably 60% by weight or higher, more preferably 70% by weight or higher, or yet more preferably 75% by weight or higher (e.g. 85% by weight or higher). The maximum alkyl (meth)acrylate content is not particularly limited; it is preferably 95% by weight or lower (e.g. 90% by weight or lower).

Secondary monomers capable of introducing possible crosslinking points into the acrylic polymer or of enhancing the adhesive strength include hydroxy group-containing monomers, carboxy group-containing monomers, acid anhydride group-containing monomers, amide group-containing monomers, amino group-containing monomers, imide group-containing monomers, epoxy group-containing monomers, (meth)acryloylmorpholine, and vinyl ethers. Among them, hydroxy group-containing monomers and carboxy group-containing monomers are preferable. Hydroxy group-containing monomers are more preferable.

Favorable examples of the acrylic polymer in the art disclosed herein include an acrylic polymer in which a hydroxy group-containing monomer is copolymerized as the secondary monomer. Examples of the hydroxy group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate; polypropylene glycol mono(meth)acrylate; and N-hydroxyethyl(meth)acrylamide. Particularly preferable hydroxy group-containing monomers include a hydroxyalkyl (meth)acrylate having a linear alkyl group with two to four carbon atoms. In view of the hydrophobicity of the alkyl group, a hydroxyalkyl(meth)acrylate having a linear alkyl group with four carbon atoms is more preferable.

Other examples include an acrylic polymer in which a carboxy group-containing monomer is copolymerized as the secondary monomer. Examples of the carboxy group-containing monomer include acrylic acid (AA), methacrylic acid (MAA), carboxyethyl (meth)acrylate, carboxypentyl (meth)acrylate, itaconic acid, maleic acid, fumaric acid, crotonic acid, and isocrotonic acid. Among them, AA and MAA are preferable.

As the secondary monomer, solely one species or a combination of two or more species can be used. When the monomers forming the acrylic polymer comprises a functional group-containing monomer, from the standpoint of the cohesive strength, etc., the ratio of the functional group-containing monomer in the monomers is suitably 0.1% by weight or higher, preferably 1% by weight or higher, or more preferably 3% by weight or higher. The upper limit is preferably about 30% by weight or lower (e.g. 25% by weight or lower). The ratio of the hydroxy group-containing monomer to all the monomers is suitably about 2% by weight or higher, preferably 5% by weight or higher, more preferably 12% by weight or higher, or yet more preferably 16% by weight or higher. In view of the properties brought about by the primary monomer, the maximum ratio of the hydroxy group-containing monomer is suitably, for instance, 30% by weight or lower (typically 24% by weight or lower).

As the monomers forming the acrylic polymer, for a purpose such as increasing the cohesive strength of the acrylic polymer, other comonomers can be used besides the aforementioned secondary monomers. Examples of the comonomers include vinyl ester-based monomers such as vinyl acetate; aromatic vinyl compounds such as styrene; cycloalkyl (meth)acrylates such as cyclohexyl (meth)acrylate; aromatic ring-containing (meth)acrylates such as aryl (meth)acrylates; olefinic monomers such as ethylene, propylene, isoprene, butadiene and isobutylene; polyfunctional monomers such as 1,6-hexanediol di(meth)acrylate, having two or more (e.g. three or more) polymerizable functional groups (e.g. (meth)acryloyl groups) per molecule.

The amount of the other comonomers can be suitably selected in accordance to the purpose and application and is not particularly limited. It is preferably 10% by weight or less (e.g. 1% by weight or less) of the monomers.

The composition of the monomers forming the acrylic polymer is suitably designed so that the acrylic polymer has a glass transition temperature (Tg) in a prescribed range. Here, the Tg of the acrylic polymer refers to the value determined by the Fox equation based on the composition of the monomers. As shown below, the Fox equation is a relational expression between the Tg of a copolymer and glass transition temperatures Tgi of homopolymers of the respective monomers constituting the copolymer.

1/Tg=Σ(Wi/Tgi)

In the Fox equation, Tg represents the glass transition temperature (unit: K) of the copolymer, Wi the weight fraction (copolymerization ratio by weight) of a monomer i in the copolymer, and Tgi the glass transition temperature (unit: K) of homopolymer of the monomer i.

As the glass transition temperatures of homopolymers used for determining the Tg value, values found in publicly known documents are used. For instance, with respect to the monomers listed below, the following values are used as the glass transition temperatures of their homopolymers.

| | |
|---|---|
| 2-ethylhexyl acrylate | −70° C. |
| n-butyl acrylate | −55° C. |
| ethyl acrylate | −22° C. |
| lauryl acrylate | 0° C. |
| 2-hydroxyethyl acrylate | −15° C. |
| 4-hydroxybutyl acrylate | −40° C. |
| acrylic acid | 106° C. |
| methacrylic acid | 228° C. |

As for the glass transition temperatures of homopolymers of other monomers besides those exemplified above, the values given in “Polymer Handbook” (3rd edition, John Wiley & Sons, Inc., Year 1989) can be used. When the literature provides two or more values for a certain monomer, the highest value is used.

While no particular limitations are imposed, from the standpoint of the adhesion, the acrylic polymer's Tg is advantageously about 0° C. or lower, or preferably about −5° C. or lower (e.g. about −15° C. or lower, or −25° C. or lower). From the standpoint of the PSA layer's cohesive strength, the acrylic polymer's Tg is about −75° C. or higher, or preferably about −70° C. or higher (e.g. −50° C. or higher, or even −30° C. or higher). The acrylic polymer's Tg can be adjusted by suitably changing the monomer composition (i.e. the monomer species used for synthesizing the polymer and their ratio).

The acrylic polymer's Mw is not particularly limited. For instance, it can be about 10×10⁴ or higher and 500×10⁴ or lower. From the standpoint of the cohesion, the Mw is about 30×10⁴ or higher and suitably about 45×10⁴ or higher (e.g. about 65×10⁴ or higher). In a preferable embodiment, the acrylic polymer's Mw is 70×10⁴ or higher, more preferably about 90×10⁴ or higher, or yet more preferably about 110×10⁴ or higher. The Mw is suitably 300×10⁴ or lower (more preferably about 200×10⁴ or lower, e.g. about 150×10⁴ or lower).

It is noted that Mw is determined from a value obtained based on standard polystyrene by GPC. As the analyzer, for instance, model name HLC-8320 GPC (columns: TSKgel GMH-H(S) available from Tosoh Corporation) can be used.

The method for obtaining the acrylic polymer is not particularly limited. Various polymerization methods known as synthetic methods of acrylic polymers may be appropriately employed, such as solution polymerization, emulsion polymerization, bulk polymerization, suspension polymerization and photopolymerization. For instance, solution polymerization may be preferably employed. As the method for supplying the monomers when solution polymerization is carried out, all-at-once supply by which all starting monomers are supplied at once, continuous supply (addition), portion-wise supply (addition) and like method can be suitably employed. The polymerization temperature can be appropriately selected according to the species of monomers, solvent, and polymerization initiator used, etc. It can be, for instance, about 20° C. to 170° C. (typically about 40° C. to 140° C.). In a preferable embodiment, the polymerization temperature can be about 75° C. or lower (more preferably about 65° C. or lower, e.g. about 45° C. to 65° C.).

As the solvent (polymerization solvent) used for solution polymerization, a suitable solvent can be selected among heretofore known organic solvents. For instance, it is possible to use one kind of solvent or a mixture of two or more kinds of solvents, selected among aromatic compounds (e.g., aromatic hydrocarbons) such as toluene and xylene; acetic acid esters such as ethyl acetate; aliphatic or alicyclic hydrocarbons such as hexane; lower alcohols such as isopropanol; ketones; and the like.

The initiator used in the polymerization can be suitably selected among heretofore known polymerization initiators in accordance with the polymerization method. For instance, one, two or more species of azo-based polymerization initiator can be preferably used, such as 2,2′-azobisisobutylonitrile (AIBN). Other examples of polymerization initiator include peroxide-based initiators such as benzoyl peroxide (BPO) and hydrogen peroxide. Other polymerization initiators include persulfates such as potassium persulfate; substituted ethane-based initiators such as phenyl-substituted ethane; aromatic carbonyl compounds; and redox-based initiators by a combination of a peroxide and a reducing agent. Among these polymerization initiators, solely one species or a combination of two or more species can be used. The polymerization initiator can be used in a typical amount selected from a range of, for instance, about 0.005 part to 1 part (typically about 0.01 part to 1 part) by weight to 100 parts by weight of the monomers.

### (Blend of Acrylic Polymer and Rubber-Based Polymer)

The PSA layer according to an embodiment of the art disclosed herein is a rubber acrylic blend PSA layer comprising a rubber-based polymer and an acrylic polymer as the base polymer. As the rubber-based polymer, one, two or more species can be used among the aforementioned rubber-based polymers. As the acrylic polymer, one, two or more species can be used among the aforementioned acrylic polymers. The rubber-based polymer and acrylic polymer can be suitably mixed together to preferably combine the rubber-based polymer's advantage (moisture resistance, etc.) and acrylic polymer's advantage (low level of outgassing, adhesive properties, etc.). When a rubber-based polymer and an acrylic polymer are used together, the weight ratio of rubber based polymer (R) to acrylic polymer (A), R/A, can be, for instance, 95/5 to 20/80; it is preferably 90/10 to 30/70, more preferably 80/20 to 40/60, or yet more preferably 70/30 to 50/50.

In an embodiment using an acrylic polymer and a rubber-based polymer together as described above, because of their difference in molecular weight, it is possible to preferably bring about airtightness and moisture resistance based on the lower molecular weight polymer as well as adhesive properties (cohesive strength, etc.) based on the higher molecular weight polymer. From such a standpoint, the ratio (M_{AC}/M_{R}) of acrylic polymer's Mw (M_{AC}) to rubber polymer's Mw (M_{R}) is higher than 1, preferably about 3 or higher, more preferably about 5 or higher, or yet more preferably about 10 or higher (e.g. about 15 or higher). The maximum M_{AC}/M_{R} ratio value is suitably about 100 or lower, preferably about 50 or lower, more preferably about 30 or lower, or yet more preferably about 20 or lower. As for the Mw of the acrylic polymer used in the blend, a suitable range can be selected from the aforementioned Mw (ranges) of the acrylic polymer. As the Mw of the rubber based polymer used in the blend, a suitable range can be selected from the aforementioned Mw (ranges) of the rubber-based polymer (e.g., the aforementioned Mw (ranges) of the isobutylene-based polymer, Mw (ranges) of polyisobutylene and Mw (ranges) of butyl rubber). The same is true with Mw/Mn.

### (Crosslinking Agent)

The PSA composition (preferably a solvent-based PSA composition) used for forming the PSA layer preferably comprises a crosslinking agent as an optional component. The PSA layer in the art disclosed herein may include the crosslinking agent in a post-crosslinking-reaction form, a pre-crosslinking-reaction form, a partially-crosslinked form, an intermediate or combined form of these, etc. In typical, the crosslinking agent is mostly included in the PSA layer in the post-crosslinking-reaction form.

The type of crosslinking agent is not particularly limited. A suitable species can be selected and used among heretofore known crosslinking agents. Examples of the crosslinking agent include isocyanate-based crosslinking agents, epoxy-based crosslinking agents, oxazoline-based crosslinking agents, aziridine-based crosslinking agents, melamine-based crosslinking agents, carbodiimide-based crosslinking agents, hydrazine-based crosslinking agents, amine-based crosslinking agents, peroxide-based crosslinking agents, metal chelate-based crosslinking agents, metal alkoxide-based crosslinking agents, and metal salt-based crosslinking agents. For the crosslinking agent, solely one species or a combination of two or more species can be used. Examples of the crosslinking agent that can be preferably used in the art disclosed herein include isocyanate-based crosslinking agents and epoxy-based crosslinking agents. In particular, isocyanate-based crosslinking agents are more preferable.

As the isocyanate-based crosslinking agent, it is preferable to use a polyfunctional isocyanate (which refers to a compound having an average of two or more isocyanate groups per molecule, including a compound having an isocyanurate structure). For the isocyanate-based crosslinking agent, solely one species or a combination of two or more species can be used. Examples of preferable polyfunctional isocyanates include a polyfunctional isocyanate having an average of three or more isocyanate groups per molecule. Such a tri-functional or higher polyfunctional isocyanate can be a multimer (e.g. dimer or trimer), a derivative (e.g., an addition product of a polyol and two or more polyfunctional isocyanate molecules), a polymer, and the like whereof bi-functional or tri-functional isocyanate(s). Examples include polyfunctional isocyanates such as dimer and trimer of diphenylmethane diisocyanate, an isocyanurate (a trimer adduct of isocyanurate structure) of hexamethylene diisocyanate, product of reaction between trimethylolpropane and tolylene diisocyanate, product of reaction between trimethylolpropane and hexamethylene diisocyanate, polymethylene polyphenyl isocyanate, polyether polyisocyanate, and polyester polyisocyanate.

As the epoxy-based crosslinking agent, a compound having two or more epoxy groups per molecule can be used without particular limitations. A preferable epoxy-based crosslinking agent has three to five epoxy groups per molecule. For the epoxy-based crosslinking agent, solely one species or a combination of two or more species can be used. While no particular limitations are imposed, specific examples of the epoxy-based crosslinking agent include N,N,N′,N′-tetraglycidyl-m-xylenecliamine, 1,3-bis(N,N-diglycidylaminomethyl)cyclohexane, 1,6-hexanediol diglycidyl ether, polyethylene glycol diglycidyl ether, and polyglycerol polyglycidyl ether.

The crosslinking agent content in the PSA composition disclosed herein is not particularly limited. From the standpoint of the cohesion, to 100 parts by weight of the base polymer (e.g. acrylic polymer), it is suitably about 0.001 part by weight or more, preferably about 0.002 part by weight or more, more preferably about 0.005 part by weight or more, or yet more preferably about 0.01 part by weight or more. From the standpoint of the adhesive strength and elastic modulus, the crosslinking agent content in the PSA composition is, to 100 parts by weight of the base polymer (e.g. acrylic polymer), about 20 parts by weight or less, suitably about 15 parts by weight or less, or preferably about 10 parts by weight or less (e.g. about 5 parts by weight or less).

In the embodiment using an isocyanate-based crosslinking agent, its amount used is not particularly limited. The isocyanate-based crosslinking agent can be used in an amount of, for instance, about 0.5 part by weight or more and about 10 parts by weight or less to 100 parts by weight of the base polymer (e.g. an acrylic polymer). From the standpoint of the cohesion, the amount of isocyanate-based crosslinking agent used to 100 parts by weight of the base polymer (e.g. an acrylic polymer) is suitably about 1 part by weight or more, or preferably about 1.5 parts by weight or more. The amount of isocyanate-based crosslinking agent used to 100 parts by weight of the base polymer (e.g. an acrylic polymer) is suitably about 8 parts by weight or less, or preferably about 5 parts by weight or less (e.g. about less than 4 parts by weight).

### (Other Additives)

The PSA composition may comprise, as necessary, various additives generally used in the PSA field, such as tackifier (tackifier resin), leveling agent, crosslinking accelerator, plasticizer, fillers, colorants including pigments and dyes, softening agent, anti-static agent, anti-aging agent, UV-absorbing agent, antioxidant and photo-stabilizing agent. With respect to these various additives, heretofore known species can be used by typical methods. In the art disclosed herein, the amount of outgassing from the PSA sheet is limited to or below a prescribed value. Thus, it is desirable to avoid using a low-molecular-weight component which may be susceptible to outgassing. From such a standpoint, the other additive content (e.g. tackifier resin) in the PSA layer is preferably limited to or below about 10% by weight (e.g. to or below 5% by weight, typically to or below 3% by weight). The art disclosed herein can be preferably implemented in an embodiment where the PSA layer is essentially free of other additives (e.g. tackifier resin).

The PSA layer can be formed based on a method for forming a PSA layer in a known PSA sheet. For example, it is preferable to use a method (direct method) where a PSA composition having PSA-layer-forming materials dissolved or dispersed in a suitable solvent is directly provided (typically applied) to a substrate (e.g. a gas barrier layer) and allowed to dry to form a PSA layer. In another method (transfer method) that can be employed, the PSA composition is provided to a highly-releasable surface (e.g. a surface of a release liner, a substrate's back face that has been treated with release agent, etc.) and allowed to dry to form a PSA layer on the surface, and the PSA layer is transferred to a support substrate (e.g. a gas barrier layer). As the release face, a surface of a release liner, a substrate's back face that has been treated with release agent, and the like can be used. The PSA layer disclosed herein is typically formed in a continuous manner.

The form of the PSA composition is not particularly limited. For instance, it can be in various forms, such as a PSA composition (a solvent-based PSA composition) that comprises PSA-layer-forming materials as described above in an organic solvent, a PSA composition (water-dispersed PSA composition, typically an aqueous emulsion-based PSA composition) in which the PSA is dispersed in an aqueous solvent, a PSA composition that is curable by an active energy ray (e.g. UV ray), and a hot-melt PSA composition. From the standpoint of the ease of application and the adhesive properties, a solvent-based PSA composition can be preferably used. As the solvent, it is possible to use one species of solvent or a mixture of two or more species, selected among aromatic compounds (typically aromatic hydrocarbons) such as toluene and xylene; acetic acid esters such as ethyl acetate and butyl acetate; and aliphatic or alicyclic hydrocarbons such as hexane, cyclohexane, heptane and methyl cyclohexane. While no particular limitations are imposed, it is usually suitable to adjust the solvent-based PSA composition to include 5% to 30% non-volatiles (NV) by weight. Too low an NV tends to result in higher production costs while too high an NV may degrade the handling properties such as the ease of application.

The PSA composition can be applied, for instance, with a known or commonly used coater such as gravure roll coater, reverse roll water, kiss roll coater, dip roll coater, bar coater, knife water, and spray coater.

In the art disclosed herein, the thickness of the PSA layer forming the adhesive face is not particularly limited. The PSA layer has a thickness of suitably 3 μm or greater, preferably 10 μm or greater, or more preferably 20 μm or greater. With increasing thickness of the PSA layer, the adhesive strength to adherend tends to increase. Having at least a certain thickness, the PSA layer absorbs the adherend's surface roughness to form tight adhesion. When the PSA layer has a thickness of 10 μm or greater, for instance, it can provide good, tight adhesion to an adherend having a surface whose arithmetic mean surface roughness Ra is about 1 μm to 5 μm (e.g. 3 μm). The thickness of the PSA layer forming the adhesive face can be, for instance, 150 μm or less; it is suitably 100 μm or less, or preferably 50 μm or less. With decreasing thickness of the PSA layer, it tends to show a greater ability to inhibit water vapor from laterally permeating the PSA layer, leading to reduction of outgassing from the PSA layer. A smaller thickness of the PSA layer is also advantageous from the standpoint of reducing the thickness and weight of the PSA sheet.

### (Properties of PSA Layer)

The storage modulus at 25° C., G′(25° C.), of the PSA layer disclosed herein is not particularly limited and it can be set in a suitable range according to required properties, etc. In a preferable embodiment, the G′(25° C.) is less than 0.5 MPa. The PSA layer whose G′(25° C.) is at or below a prescribed value wets the adherend surface well to form tight adhesion. The G′(25° C.) is more preferably 0.4 MPa or less, yet more preferably 0.3 MPa or less, or particularly preferably 0.25 MPa or less. The G′(25° C.) can also be, for instance, 0.2 MPa or less. The G′(25° C.) value is not particularly limited and is suitably greater than about 0.01 MPa, preferably 0.05 MPa or greater, or more preferably 0.07 MPa or greater (e.g. 0.1 MPa or greater).

In the art disclosed herein, the storage modulus G′(25° C.) of a PSA layer can be determined by dynamic elastic modulus measurement. In particular, several layers of the PSA subject to measurement are layered to fabricate an approximately 2 mm thick PSA layer. A specimen obtained by punching out a disc of 7.9 mm diameter from the PSA layer is fixed between parallel plates. With a rheometer (e.g. ARES available from TA Instruments or a comparable system), dynamic elastic modulus measurement is carried out to determine storage modulus G′(25° C.). The PSA (layer) subject to measurement can be formed by applying a layer the corresponding PSA composition on a release face of a release liner or the like and allowing it to dry or cure. The thickness (coating thickness) of the PSA layer subjected to the measurement is not particularly limited as long as it is 2 mm or less. It can be, for instance, about 50 μm.

Measurement mode: shear mode

Temperature range: −50° C. to 150° C.

Heating rate: 5° C./min

Measurement frequency: 1 Hz

The same measurement method is also used in the working examples described later.

### <Gas Barrier Layer>

With respect to the gas barrier layer in the art disclosed herein, no particular limitations are imposed on the material and form of layering as long as the layer (film) has gas barrier properties. The gas barrier layer (film) preferably has a moisture permeability (a water vapor transmission rate in the thickness direction) lower than 5×10⁻¹ g/m² when determined per 24 hours at 40° C. at 90% RH based on the MOCON method (JIS K7129:2008). A layer having such moisture impermeability is also referred to as a “moisture-impermeable layer” here. With the use of the gas barrier layer satisfying this property, it is possible to obtain a PSA sheet having gas barrier properties in the thickness direction. The moisture permeability is preferably lower than 5×10⁻² g/m², or more preferably lower than 5×10⁻³ g/m², for instance, lower than 5×10⁻⁵ g/m². As the moisture permeability tester, PERMATRAN-W3/33 available from MOCON, Inc. or a comparable product can be used. It is noted that in the PSA sheet disclosed herein, the gas barrier layer can be a substrate (support substrate) that supports the PSA layer.

In a preferable embodiment, the gas barrier layer disclosed herein includes an inorganic layer. The material or structure of the inorganic layer is not particularly limited and can be selected in accordance of the purpose and usage. From the standpoint of the airtight properties and moisture resistance, it is advantageous that the inorganic layer is essentially non-porous. In typical, a preferable inorganic layer is essentially formed of an inorganic material. For instance, an inorganic layer formed of at least 95% (by weight) inorganic material is preferable (more preferably at least 98% by weight, or yet more preferably at least 99% by weight). The number of inorganic layers in the gas barrier layer is not particularly limited; it can be one, two or more (e.g. about two to five). From the standpoint of the ease of manufacturing and availability, the number of inorganic layers in the gas barrier layer is preferably about 1 to 3, or more preferably one or two. When the gas barrier layer includes several inorganic layers, the materials and structures (thicknesses, etc.) of these inorganic layers can be the same with or different from one another.

As the inorganic material forming the inorganic layer, it is possible to use, for instance, metal materials including elemental metals such as aluminum, copper, silver, iron, tin, nickel, cobalt, and chromium as well as alloys of these; and inorganic compounds such as oxides, nitrides and fluorides of metals and metalloids including silicon, aluminum, titanium, zirconium, tin and magnesium. Specific examples of the inorganic compounds include silicon oxides (SiOₓ, typically SiO₂), aluminum oxide (Al₂O₃), silicon nitride (Si₃N₄), silicon oxide nitride (SiOₓN_{y}), titanium oxide (TiO₂), and indium tin oxide (ITO).

The metal materials can be used as the inorganic layers as metal foils (e.g. aluminum foil) formed by a known method such as rolling by a rolling mill, etc. Alternatively, for instance, a metal material formed in a layer by a known film-forming method such as vacuum vapor deposition, spattering and plating.

The inorganic compound can be typically used as the inorganic layer in a form of thin film formed by a known method. As the method for forming thin film of the inorganic compound, various vapor deposition methods can be used. For instance, physical vapor deposition methods (PVD) such as vacuum vapor deposition, spattering and ion plating, chemical vapor deposition methods (CVD) and like method can be used. The gas barrier layer may further have a resin layer on top of the vapor deposition layer. For instance, the resin layer may be a topcoat layer provided for purposes such as protecting the vapor deposition layer.

From the standpoint of the gas barrier properties, ease of manufacturing, availability, etc., it is preferable to use an inorganic layer formed of metal materials, for instance, aluminum or an aluminum alloy. From the standpoint of the gas barrier properties, ease of manufacturing, availability, etc., as the inorganic layer formed of an inorganic compound, for instance, a silicon oxide layer or an aluminum oxide layer can be preferably used. Examples of an inorganic layer preferable for being able to form a highly transparent inorganic layer include a silicon oxide layer, an aluminum oxide layer and an ITO layer.

The maximum thickness of the inorganic layer is not particularly limited. From the standpoint of obtaining conformability to shapes of adherends, the inorganic layer advantageously has a thickness of 50 μm or less. From the standpoint of reducing the thickness and weight of the PSA sheet, the thickness of the inorganic layer is suitably 15 μm or less, preferably 13 μm or less, more preferably 11 μm or less, or yet more preferably 9 μm or less. When the gas barrier layer includes several inorganic layers, the combined thickness of these inorganic layers is preferably in these ranges. The minimum thickness of the inorganic layer is not particularly limited and can be suitably selected so as to obtain a PSA sheet that shows gas barrier properties suited for the purpose and usage. The thickness of the inorganic layer is suitably 1 nm or greater. From the standpoint of the airtight properties, moisture resistance, etc., it is preferably 2 nm or greater, or more preferably 5 nm or greater. When the gas barrier layer includes several inorganic layers, it is preferable that at least one of them has a thickness in these ranges. Each of the several inorganic layers may have a thickness in these ranges as well.

The preferable thickness range of the inorganic layer may also vary depending on the material of the inorganic layer, the formation method, etc. For instance, when metal foil (e.g. aluminum foil) forms the inorganic layer (or the metal layer), in view of the gas barrier properties, ease of manufacturing, crease resistance, etc., its thickness is suitably 1 μm or greater, preferably 2 μm or greater, or more preferably 5 μm or greater. In view of the flexibility which leads to adherend conformability, the metal layer's thickness is suitably 50 μm or less, preferably 20 μm or less, more preferably 15 μm or less, yet more preferably 12 μm or less, or particularly preferably 10 μm or less. With respect to the inorganic layer formed by vapor deposition of an inorganic compound, in view of the gas barrier properties of the PSA sheet and the balance between the gas barrier layer's flexibility and ease of manufacturing, its thickness is suitably in a range between 1 nm and 1000 nm, preferably in a range between 2 nm and 300 nm, or more preferably in a range between 5 nm and less than 100 nm.

The gas barrier layer disclosed herein may include a resin layer in addition to the inorganic layer. The resin layer may serve as a protection layer to prevent the inorganic layer from getting damaged by bending deformation and friction. Thus, the gas barrier layer including the resin layer in addition to the inorganic layer is preferable from the standpoint of the endurance and reliability of gas barrier properties and also from the standpoint of the ease of handling the gas barrier layer or the PSA sheet. By placing the resin layer on the PSA layer side surface of the gas barrier layer, the anchoring of the PSA layer can be enhanced. When the inorganic layer is formed by vapor deposition, spattering or like method, the resin layer can be used as the base for forming the inorganic layer.

The structure of the resin layer is not particularly limited. For instance, the resin layer may include a void space as in fiber assemblies such as woven fabrics and non-woven fabrics or as in foam bodies such as polyethylene foam; or it can be a resin layer (resin film) essentially free of a void space. From the standpoint of reducing the thickness of the PSA sheet, it is preferable use a resin layer essentially free of a void space.

As the resin material forming the resin layer, it is possible to use, for instance, polyester resins such as polyethylene terephthalate (PET), polybutylene terephthalate (PBT) and polyethylene naphthalate (PEN); polyolefin resins such as polyethylene (PE) and polypropylene (PP); polyimide (PI); polyetheretherketone (PEEK); chlorine-containing polymers such as polyvinyl chloride (PVC) and polyvinylidene chloride; polyamide-based resins such as nylon and aramid; polyurethane resin; polystyrene-based resin; acrylic resins; fluororesins; cellulose-based resins; and polycarbonate-based resins. Of these, solely one species or a combination of two or more species can be used. When two or more species of resin are used together, these resins can be used blended or separately. Both thermoplastic resins and thermosetting resins can be used. From the standpoint of the ease of forming film, etc., a thermoplastic resin is preferably used.

In the gas barrier layer including a resin layer, at an edge face of the PSA sheet, water vapor permeation into the resin layer through its side (lateral surface) or inner gas leak may occur. From the standpoint of inhibiting such gas leak and entrance of water vapor, as the resin material forming the resin layer, a highly airtight and moisture-resistant material can be preferably used. For instance, a preferable resin layer is formed, using a resin material whose primary component is a polyester resin such as PET or a polyolefinic resin such as PE and PP. In a preferable embodiment, PET film can be preferably used as the resin layer. In another preferable embodiment, as the resin layer, it is preferable to use BOPP (biaxially oriented polypropylene) film obtainable by forming film of a resin material that comprises PP as the primary component and biaxially stretching the film. In the PSA sheet having no inorganic layer further on the adherend side relative to the resin layer, it is particularly significant to inhibit gas leak and entrance of water vapor from the lateral surface of the resin layer. A typical example of the PSA sheet having such a constitution is a PSA sheet in which the PSA layer side surface of the gas barrier layer is formed with a resin layer.

The resin layer may include, as necessary, various additives such as fillers (inorganic fillers, organic fillers, etc.), anti-aging agent, antioxidant, UV absorber, anti-static agent, slip agent and plasticizer. The ratio of the various additives included is below about 30% by weight (e.g. below 20% by weight, typically below 10% by weight).

The number of resin layers in the gas barrier layer is not particularly limited and it can be one, two or more (e.g. about two to five). From the standpoint of the ease of manufacturing and availability, the number of resin layers in the gas barrier layer is preferably one to three, or more preferably one or two. When the gas barrier layer includes several resin layers, the materials and structures (thicknesses, inclusion of a void space, etc.) of these resin layers can be the same with or different from one another.

The method for forming the resin layer is not particularly limited. A heretofore known general resin film molding method can be suitably employed to form the resin layer, for instance, extrusion molding, inflation molding, T-die casting, calender roll molding and wet casting. The resin layer may a non-stretched kind or may be subjected to a stretching process such as uni-axial stretching and bi-axial stretching.

The minimum thickness of the resin layer is not particularly limited. From the standpoint of the crease resistance, ease of forming film, etc., the thickness of the resin layer is suitably 1 μm or greater, preferably 3 μm or greater, more preferably 5 μm or greater, or yet more preferably 7 μm or greater. When the gas barrier layer includes several resin layers, it is preferable that at least one of them has a thickness in these ranges. Each of the several resin layers may have a thickness in these ranges as well.

The maximum thickness of the resin layer is not particularly limited. For instance, it can be 100 μm or less. From the standpoint of reducing the thickness and weight of the PSA sheet, the thickness of the resin layer is suitably 70 μm or less, preferably 55 μm or less, or more preferably 35 μm or less. When the gas barrier layer includes several resin layers, the combined thickness of these resin layers is preferably in these ranges. In general, the gas permeability and moisture permeability of the resin layer is higher than those of the inorganic layer. Thus, it is also preferable to make the combined thickness of resin layers smaller from the standpoint of preventing water vapor permeation into the resin layer through its side (lateral surface) and inner gas leak, at an edge face of the PSA sheet.

The inorganic layer and the resin layer are preferably bonded. The bonding method is not particularly limited. A method known in the pertinent field can be suitably employed. For instance, it is possible to employ a method (extrusion lamination) where a resin material for forming the resin layer is melted and extruded along with a pre-molded inorganic layer (typically metal foil), a method where a solution or dispersion of the resin material for forming the resin layer is applied to a pre-molded inorganic layer and allowed to dry, and like method. Alternatively, it is also possible to employ a method where an inorganic layer is vapor-deposited on a pre-molded resin layer, a method where an inorganic layer is bonded to a separately-molded resin layer, and like method. For instance, the bonding can be achieved by hot pressing. The resin layer and the inorganic layer can be bonded via an adhesive layer or a PSA layer.

The adhesive layer to bond the resin layer and the inorganic layer can be an undercoat layer formed by applying an undercoat such as primer to the resin layer. As the undercoat, those known in the pertinent field can be used, such as urethane-based undercoat, ester-based undercoat, acrylic undercoat, and isocyanate-based undercoat. From the standpoint of reducing the thickness and weight of the PSA sheet, the thickness of the undercoat layer is suitably 7 μm or less, preferably 5 μm or less, or more preferably 3 μm or less. The minimum thickness of the undercoat layer is not particularly limited. For instance, it can be 0.01 μm or greater (typically 0.1 μm or greater).

Before the bonding process, the resin layer may be subjected to common surface treatment, chemical or physical treatment, for instance, mattifying treatment, corona discharge treatment, crosslinking treatment, chromic acid treatment, ozone exposure, flame exposure, high-voltage electric shock exposure, and ionized radiation treatment.

The PSA layer(s) placed between layers forming the gas barrier layer to bond them together are not exposed to the surface of the PSA sheet; and therefore, they do not correspond to the PSA layer forming the adhesive face of the PSA sheet. In the PSA sheet disclosed herein, the material and physical properties of such a PSA layer for internal use in the gas barrier layer are not particularly limited. The PSA layer can be formed of a PSA similar to the PSA layer forming the adhesive face or can be formed of a different PSA. It is not particularly limited in thickness, either. For instance, it may have a comparable thickness to the undercoat layer.

Favorable examples of the gas barrier layer used in the PSA sheet disclosed herein include a gas barrier layer formed of a laminate body that comprises an inorganic layer as well as first and second resin layers laminated on top and bottom of the inorganic layer. The first and second resin layers forming the gas barrier layer are laminated on top and bottom of the inorganic layer. As long as such a layer order can be obtained, the first and second resin layers may be in direct contact with the inorganic layer or they may be placed via undercoat layers as described above to obtain tight adhesion between themselves and the inorganic layer. In the PSA sheet disclosed herein, the first resin layer refers to the resin layer placed on the backside (the front face of the gas barrier layer) of the PSA sheet relative to the inorganic layer and the second resin layer refers to the resin layer placed on the PSA layer side.

The inorganic layer can be a metal layer formed of an aforementioned metal material. For instance, an aluminum layer is preferable. The first and second resin layers are preferably formed from the same material. For instance, thermoplastic resins exemplified above can be used. Of these materials, solely one species or a combination of two or more species can be used. Each of the first and second resin layers may have a layered structure with two or more layers, but is preferably a monolayer. In particular, preferable materials forming the first and second resin layers include PET, PP and polystyrene. PET and PP are more preferable.

The first and second resin layers have thicknesses T_{R1} and T_{R2}, respectively; and their ratio (T_{R1}/T_{R2}) is not particularly limited, but is suitably 0.5 or greater, preferably 1 or greater, more preferably 1.5 or greater, or yet more preferably 2.0 or greater. The T_{R1}/T_{R2} ratio is suitably about 10 or less, preferably 7.0 or less, more preferably 5.0 or less, or yet more preferably 4.0 or less. When the T_{R1}/T_{R2} ratio is in these ranges, adherend conformability and crease resistance can be preferably combined. The thickness T_{R1} of the first resin layer is suitably about 10 μm or greater, preferably 15 μm or greater, more preferably 18 μm or greater, or yet more preferably 20 μm or greater (e.g. 22 μm or greater). T_{R1} is suitably about 100 μm or less, preferably 70 μm or less, more preferably 60 μm or less, yet more preferably 50 μm or less, or particularly preferably 35 μm or less. The thickness T_{R2} of the second resin layer is suitably about 1 μm or greater, preferably 3 μm or greater, more preferably 5 μm or greater, or yet more preferably 7 μm or greater. T_{R2} is suitably about 25 μm or less, preferably 20 μm or less, more preferably 15 μm or less, or yet more preferably 12 μm or less (e.g. 10 μm or less).

The inorganic layer has a thickness T₁ and the first and second resin layers have a combined thickness T_{R} (=T_{R1}+T_{R2}); and their ratio (T_{R}/T₁) is not particularly limited. From the standpoint of preventing creases, protecting the inorganic layer, etc., the ratio is suitably 1 or greater, preferably 2 or greater, more preferably 3 or greater, or yet more preferably 4 or greater. When it is bent and applied to accommodate the adherend shape, in view of the adherend conformability, the T_{R}/T₁ ratio is suitably 10 or less, preferably 8 or less, or more preferably 6 or less. The total (T_{R}) of the first and second resin layers' thicknesses T_{R1} and T_{R2} is suitably about 15 μm or greater, preferably 20 μm or greater, more preferably 25 μm or greater, or yet more preferably 30 μm or greater. T_{R} is suitably about 100 μm or less, preferably 80 μm or less, more preferably 70 μm or less, or yet more preferably 60 μm or less (e.g. 50 μm or less). The gas barrier layer in this embodiment can effectively protect the inorganic layer (e.g. an aluminum layer) as thin film from bending, creasing, breaking, etc. By this, even when the PSA sheet is exposed to various stressors in the manufacturing process, etc., or even when it is exposed to a harsh environment for a long period while in use, it can securely maintain the properties as the gas barrier film.

As the method for forming a laminate body having the inorganic layer, first resin layer and second resin layer, it is possible to employ various methods as described earlier, such as a method where the respective layers are formed as films by a known method and they are laminated dry by forming undercoat layers described above, a method where the inorganic layer is formed on the first resin layer in a tightly bonded manner and the second resin layer is laminated dry or extrusion-laminated on top of it, and like method.

The minimum thickness of the gas barrier layer is not particularly limited. From the standpoint of the ease of manufacturing and handling the PSA sheet, the thickness of the gas barrier layer is about 3 μm or greater, or suitably about 5 μm or greater (e.g. 10 μm or greater). To obtain airtightness, moisture resistance and rigidity unsusceptible to creasing, it is desirable that the gas barrier layer is thick. From such a standpoint, the thickness of the gas barrier layer is preferably 15 μm or greater, more preferably 20 μm or greater, yet more preferably 30 μm or greater, or particularly preferably 40 μm or greater. The maximum thickness of the gas barrier layer is not particularly limited, either. It is about 1 mm or less, or suitably about 300 μm or less (e.g. 150 μm or less). From the standpoint of the adherend conformability of the PSA sheet and of reducing its thickness and weight, the thickness of the gas barrier layer is preferably 100 μm or less, more preferably 80 μm or less, yet more preferably 70 μm or less, or particularly preferably 65 μm or less (e.g. 55 μm or less). The gas barrier layer with such a limited thickness is less likely to lead to formation of a space between the adherend and the PSA sheet; and therefore, it can prevent water vapor permeation and gas leak through the space.

The PSA layer side surface of the gas barrier layer may be subjected to common surface treatment, chemical or physical treatment, for instance, mattifying treatment, corona discharge treatment, crosslinking treatment, chromic acid treatment, ozone exposure, flame exposure, high-voltage electric shock exposure, and ionized radiation treatment. On the PSA layer side surface of the gas barrier layer, an undercoat layer may be placed, which is formed by applying an undercoat such as primer to the resin layer. As the undercoat, those known in the pertinent field can be used, such as urethane-based, ester-based, acrylic, and isocyanate-based kinds. From the standpoint of reducing the thickness and weight of the PSA sheet, the thickness of the undercoat layer is suitably 7 μm or less, preferably 5 μm or less, or more preferably 3 μm or less.

### <Release Liner>

In the art disclosed herein, a release liner can be used during formation of the PSA layer; fabrication of the PSA sheet; storage, distribution and shape machining of the PSA sheet prior to use, etc. The release liner is not particularly limited. For example, a release liner having a release layer on the surface of a liner substrate such as resin film and paper; a release liner formed from a low adhesive material such as a fluoropolymer (polytetrafluoroethylene, etc.) or a polyolefinic resin (PE, PP, etc.); or the like can be used. The release layer can be formed, for instance, by subjecting the liner substrate to a surface treatment with a release agent such as a silicone-based, long-chain alkyl-based, fluorine-based, or molybdenum disulfide-based release agent. When the PSA sheet is used as a sealing material for a magnetic disc device, it is preferable to use a non-silicone-based release liner free of a silicone-based release agent which may produce siloxane gas.

### <Applications>

The cover seal and PSA sheet disclosed herein have excellent airtightness; and therefore, they can be preferably used in various applications for which gas leak and gas contamination are desirably limited. For instance, the cover seal and PSA sheet disclosed herein are preferably used for sealing the internal space of a magnetic disc device such as HDD which is a type of electronic device. For instance, in a type of device filled with a low-density gas such as helium in order to reduce the influence of air flow generated by the spinning disc, helium gas leak can be prevented. In this application, an included gas such as siloxane may cause damage to the device; and therefore, it is important to prevent such gas contamination. In a magnetic disc device employing HAMR, it is important to prevent entrance of water which badly affects the recording life. By using the PSA sheet disclosed herein as a sealing material on an HAMR magnetic disc device, a magnetic recording device having a higher density can be obtained.

Matters disclosed by this description include the following:
(1) A magnetic disc device comprising

at least one data-recording magnetic disc,

a motor that rotates the magnetic disc,

a magnetic head that at least either reads or writes data on the magnetic disc,

an actuator that moves the magnetic head, and

a housing that houses the magnetic disc, the motor, the magnetic head and the actuator, the housing having an opening and/or gap through which gases can move between the internal space and outside of the housing (move in and out of the housing); and

further comprising a cover seal bonded to the housing, covering the opening and/or gap, the cover seal formed of at least one PSA sheet having a gas barrier layer and a PSA layer provided at least on one face of the gas barrier layer;

wherein the housing and the cover seal share a bonding interface that has, along its surface, a first bonding area, a non-bonding area and a second bonding area in this order from the opening and/or gap towards the outside.
(2) The magnetic disc device according to (1) above, wherein the housing comprises a box-shaped housing base member having a top opening and a cover member to cover the opening.
(3) The magnetic disc device according to (2) above, wherein the housing base member has a recessed portion around the inner circumference of the top opening and the outer rim of the cover member is placed on the bottom of the recessed portion.
(4) The magnetic disc device according to any of (1) to (3) above, wherein the cover member has a hole (an opening).
(5) The magnetic disc device according to any of (1) to (4) above, wherein the PSA sheet seals the internal space of the magnetic disc device.
(6) The magnetic disc device according to any of (1) to (5) above, wherein the PSA sheet covers and seals the top face of the housing base member of the magnetic disc device.
(7) The magnetic disc device according to any of (1) to (6) above, capable of heat-assisted magnetic recording.
(8) The magnetic disc device according to any of (1) to (7) above, having an enclosed space between the PSA layer's outer edge and the opening and/or gap.
(9) The magnetic disc device according to any of (1) to (8) above, wherein

the cover seal comprises a first PSA sheet covering the opening and/or gap and a second PSA sheet covering at least the outer edge of the first PSA sheet; and

an enclosed space is formed adjacent to where the outer edge of the first PSA sheet with the second PSA sheet overlap.
(10) The magnetic disc device according to (9) above, wherein the second PSA sheet entirely covers the first PSA sheet bonded to the housing.
(11) The magnetic disc device according to any of (1) to (10), wherein the PSA layer bearing face of the cover seal has a circular recess.
(12) The magnetic disc device according to any of (1) to (11) above, wherein, along the bonding interface between the housing and the cover seal, the first bonding area has a width from the opening and/or gap to the non-bonding area and the second bonding area has a width from the non-bonding area to the PSA layer's outer edge, with the first bonding area's width being larger than the second bonding area's width.
(13) The magnetic disc device according to any of (1) to (12) above, wherein the gas barrier layer has a moisture permeability below 5×10⁻¹ g/m², determined per 24 hours at 40° C. at 90% RH based on the MOCON method (JIS K7129:2008).
(14) An electronic device comprising a housing that forms an internal space to house components, the housing having an opening and/or gap through which gases can move between the inside (internal space) and outside of the housing; and further comprising a cover seal bonded to the housing, covering the opening and/or gap; wherein

the cover seal is formed of at least one PSA sheet having a gas barrier layer and a PSA layer provided at least on one face of the gas barrier layer, and

the housing and the cover seal share a bonding interface that has, along its surface, a first bonding area, a non-bonding area and a second bonding area in this order from the opening and/or gap towards the outside.
(15) The electronic device according to (14) above, having an enclosed space between the PSA layer's outer edge and the opening and/or gap.
(16) The electronic device according to (14) or (15), wherein

the cover seal comprises a first PSA sheet covering the opening and/or gap and a second PSA sheet covering at least the outer edge of the first PSA sheet; and

an enclosed space is formed adjacent to where the outer edge of the first PSA sheet with the second PSA sheet overlap.
(17) The electronic device according to (16) above, wherein the second PSA sheet entirely covers the first PSA sheet bonded to the housing.
(18) The electronic device according to any of (14) to (17) above, wherein the PSA layer-bearing face of the cover seal has a circular recess.
(19) The electronic device according to any of (14) to (18) above, wherein, along the bonding interface between the housing and the cover seal, the first bonding area has a width from the opening and/or gap to the non-bonding area and the second bonding area has a width from the non-bonding area to the PSA layer's outer edge, with the first bonding area's width being larger than the second bonding area's width.
(20) The electronic device according to any of (14) to (19) above, wherein the gas barrier layer has a moisture permeability below 5×10⁻¹ g/m², determined per 24 hours at 40° C. at 90% RH based on the MOCON method (JIS K7129:2008).
(21) A cover seal comprising at least one PSA sheet having a gas barrier layer and a PSA layer provided to at least one face of the gas barrier layer, wherein the PSA layer has an adhesive face that has, along its surface, a first bonding area, a non-bonding area and a second bonding area in this order.
(22) The cover seal according to (21) above, having a moisture permeability lower than 90 μg/cm² in the in-plane direction of bonding area of pressure-sensitive adhesive sheet, determined per 24 hours at a permeation distance of 2.5 mm based on the MOCON method.
(23) The cover seal according to (21) or (22) above, exhibiting an amount of thermally released gas of 10 μg/cm² or less, determined at 130° C. for 30 minutes by gas chromatography/mass spectrometry.
(24) The cover seal according to any of (21) to (23) above, having a 180° peel strength of 3 N/20 mm or greater to a stainless steel plate.
(25) The cover seal according to any of (21) to (24) above, wherein the PSA layer has a storage modulus below 0.5 MPa at 25° C.
(26) The cover seal according to any of (21) to (25) above, showing a displacement less than 2 mm in a shear holding power test carried out with a 1 kg load at 60° C. for one hour.
(27) The cover seal according to any of (21) to (26) above, wherein the PSA layer is a rubber-based PSA layer comprising a rubber-based polymer as its base polymer, an acrylic PSA layer comprising an acrylic polymer as its base polymer, or a rubber-acrylic blend PSA layer comprising a rubber based polymer and an acrylic polymer as its base polymers.
(28) The cover seal according to (27) above, wherein the PSA layer is the rubber-based PSA layer, wherein at least one species of monomer selected from the group consisting of butene, isobutylene and isoprene is polymerized in the rubber-based polymer.
(29) The cover seal according to any of (21) to (28) above, having a tensile modulus per unit width above 1000 N/cm and below 3500 N/cm.
(30) The cover seal according to any of (21) to (29) above, having a total thickness of 25 μm to 200 μm.
(31) The cover seal according to any of (21) to (30) above, wherein the gas barrier layer comprises an inorganic layer.
(32) The cover seal according to (31) above, wherein the inorganic layer is a metal layer.
(33) The cover seal according to (31) or (32) above, wherein the inorganic layer is formed of aluminum or an aluminum alloy.
(34) The cover seal according to any of (31) to (33) above, wherein the inorganic layer has a thickness of 2 μm to 20 μm.
(35) The cover seal according to any of (31) to (34) above, wherein the gas barrier layer comprises a resin layer in addition to the inorganic layer.
(36) The cover seal according to (35) above, wherein the resin layer is a polyester resin layer.
(37) The cover seal according to (35) or (36) above, wherein the resin layer has a thickness of 3 μm to 55 μm.
(38) The cover seal according to any of (31) to (37) above, wherein the gas barrier layer is formed of a laminate comprising an inorganic layer as well as first and second resin layers laminated atop and below the inorganic layer.
(39) The cover seal according to any of (21) to (38) above, used for sealing the internal space of an electronic device.
(40) The cover seal according to any of (21) to (38) above, used for sealing the internal space of a magnetic disc device.
(41) A magnetic disc device having the cover seal according to any of (21) to (40) above.
(42) The magnetic disc device according to (41) above, wherein the cover seal seals the internal space of the magnetic disc device.
(43) The magnetic disc device according to (41) or (42) above, having a housing base member whose top face is covered and sealed with the cover seal.
(44) The magnetic disc device according to any of (41) to (43) above, capable of heat-assisted magnetic recording.
(45) A method for applying a cover seal to a housing that forms an internal space to house components so as to seal the internal space, the method comprising

a step of applying a cover seal to cover an opening and/or gap of the housing, wherein

the application step is a step of applying the cover seal so that the housing and the cover seal share a bonding interface that has, along its surface, a first bonding area, a non-bonding area and a second bonding area from the opening and/or gap towards the outside.

### EXAMPLES

Empirical tests related to the present invention are described below. In the description below, “parts” and “%” are by weight unless otherwise specified.

### <Empirical Tests>

### (Fabrication of PSA Sheets)

By dry bonding lamination, were laminated 25 μm thick PET film (PET layer) as the first resin layer, 7 μm thick aluminum foil (Al layer) as the inorganic layer and 9 μm thick PET film (PET layer) as the second resin layer in this order from the front (outer surface side) to the backside (PSA layer side). Between each resin layer and the inorganic layer, was laminated a 3 μm thick adhesive layer. A 47 μm thick laminate film was thus prepared. The laminate film was used as a gas barrier layer.

In toluene, was dissolved polyisobutylene (product name OPPANOL N50 available from BASF Corporation, Mw≈34×10⁴, Mw/Mn≈5.0) as the base polymer to prepare a PSA composition with 25% NV. The PSA composition was applied to one face (the second resin layer side surface) of the gas barrier layer to have a thickness of 30 μm after dried, and allowed to dry at 120° C. for 3 minutes to form a PSA layer. A PSA sheet was thus obtained. For protection of the surface (adhesive face) of the PSA layer, was used a release liner formed of thermoplastic film treated with release agent (product name HP-SO available from Fujico Co., Ltd.; 50 μm thick).

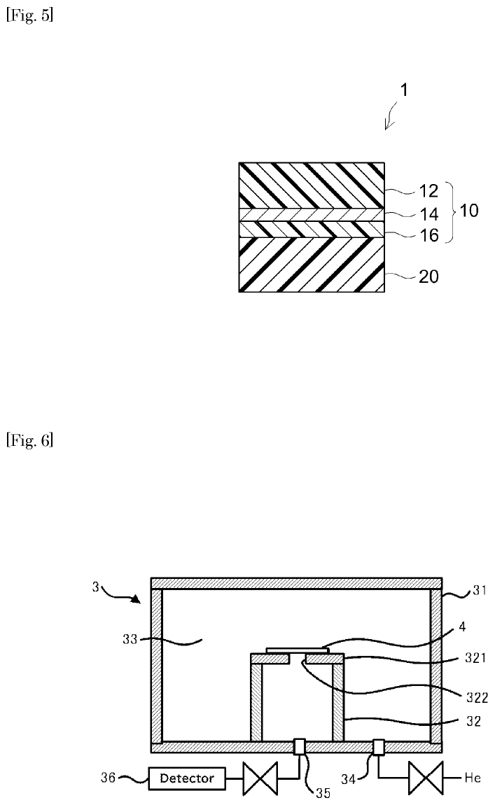

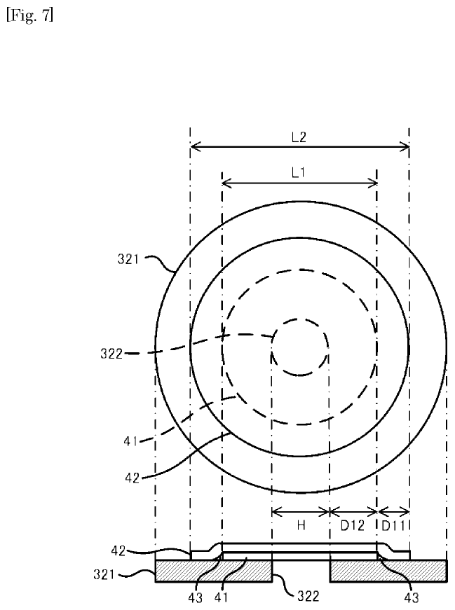

Using a test apparatus and the PSA sheets obtained above as test samples, empirical testing was conducted. FIG. 6 outlines the structure of test apparatus 3 used in the empirical testing. Test apparatus 3 has a metallic box 31. The interior of box 31 is provided with a chamber 32. The top of chamber 32 has a lid (cover) 321 having an opening 322. On lid 321, a test sample 4 is placed to cover opening 322. By this, the interior of chamber 32 is sealed. At the start of each test, chamber 32 was in an approximate vacuum (1 Pa). Before the start of each test, via an inlet 34, internal space 33 (which is inside box 31, but outside chamber 32) was filled with helium for 10 minutes. Subsequently, the rate of helium leak into chamber 32 (nPa·m³/sec) was detected with a detector 36 connected via an outlet 35 to chamber 32.

FIG. 7 outlines the configuration of lid 321 and test sample 4. As described above, test sample 4 is placed on lid 321 to cover opening 322. In this test, opening 322 had a diameter H of 10 mm. Test sample 4 has an inner sheet 41 formed of PSA sheet 1 in the embodiment described above. Alternatively, test sample 4 may have an outer sheet 42 formed of PSA sheet 1 in the same embodiment. Inner sheet 41 has a diameter L1. Outer sheet 42 has a diameter L2. Inner sheet 41 is placed on lid 321 to cover opening 322. For this, the PSA layer side of inner sheet 41 is placed on the top face of lid 321. Outer sheet 42 is placed on lid 321 and inner sheet 41 to cover inner sheet 41. For this, the PSA layer side of outer sheet 42 is placed on the top face of lid 321. Circle opening 322, inner sheet 41 and outer sheet 42 are arranged more or less concentrically. When test sample 4 is applied to lid 321 in this manner, an enclosed space 43 is formed adjacent to where the outer edge of inner sheet 41 with outer sheet 42 overlap. Enclosed space 43 is formed with the non-bonding area between the bonding area (first bonding area) of outer sheet 42 and the bonding area (second bonding area) of inner sheet 41 in the bonding interface of test sample 4 consisting of outer sheet 42 and inner sheet 41. It is noted that the first bonding area has a width D11 which is the distance ((L2−L1)/2 mm) from the edge of outer sheet 42 to the edge of inner sheet 41 (i.e. the difference in radius between sheets 41 and 42 or the distance between two nearest edge points of two circular sheets 41 and 42). The second bonding area has a width D12 which is the distance ((L1−H)/2 mm) from the edge of inner sheet 41 adjacent to enclosed space 43 to opening 322 of lid 321 (i.e. the difference in radius between inner sheet 41 and lid opening 322 or the difference between two nearest edge points of circular sheet 41 and lid opening 322). In this test, as test sample 4, were obtained test samples according to Examples 1 to 11 shown in Table 1.

TABLE 1

| | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
|---|---|---|---|---|---|---|---|---|---|---|---|
| Inner sheet diameter L1 (mm) | 14 | 16 | 20 | 30 | 14 | 14 | 14 | 16 | 20 | 20 | 30 |
| Outer sheet diameter L2 (mm) | N/A | N/A | N/A | N/A | 14 | 20 | 30 | 30 | 14 | 30 | 30 |
| D11 (L2 − L1)/2 (mm) | — | — | — | — | 0 | 3 | 8 | 7 | −3 | 5 | 0 |
| D12 (L1 − H)/2 (mm) | 2 | 3 | 5 | 10 | 2 | 2 | 2 | 3 | 5 | 5 | 10 |
| Helium leak rate (nPa · m²/sec) | 0.45 | 0.38 | 0.28 | 0.25 | 0.45 | 0.26 | 0.23 | 0.22 | 0.28 | 0.23 | 0.25 |

Each of test samples according to Examples 1 to 4 has solely one PSA sheet (which is referred to as the inner sheet for convenience). As shown in Table 1, among Examples 1 to 4, the helium leak rate decreased with increasing diameter of the PSA sheet.

The test sample according to Example 5 whose inner and outer sheets had the same diameter (14 mm) showed the same helium leak rate as Example 1 using a single PSA sheet of the same diameter. The same results were obtained in Examples 4 and 11 using sheets of 30 mm in diameter. In the test sample according to Example 9, the inner sheet diameter (20 mm) was larger than the outer sheet diameter (14 mm). This test sample had the same helium leak rate as Example 3 using a single PSA sheet of 20 mm in diameter. These results indicate that there is no difference in helium leak rate between a case using a single PSA sheet and a case using two same-sized, concentrically layered PSA sheets; and that there is no difference in effect, either, when the outer sheet having a smaller diameter than the inner sheet is overlaid.

In the test samples according to Examples 6 and 7, the diameters of the inner sheets were both 14 mm. The diameters of the outer sheets were 20 mm in Example 6 and 30 mm in Example 7. In the test sample according to Example 8, the inner sheet diameter was 16 mm and the outer sheet diameter was 30 mm. In the test sample according to Example 10, the inner sheet diameter was 20 mm and the outer sheet diameter was 30 mm. The helium leak rate of Example 6 decreased from that of Example 3 having the same sheet diameter (20 mm). Similarly, the helium leak rates of Examples 7, 8 and 10 were lower than those of Examples 4 and 11 having the same sheet diameter (30 mm). This suggests that, in an embodiment such as Examples 6, 7, 8 and 10 where an outer sheet with a large diameter was concentrically layered over an inner sheet with a small diameter, a non-bonding area was formed between the inner sheet's bonding area (second bonding area) and the outer sheet's bonding area (first bonding area); and the helium concentration decreased in the non-bonding void space, thereby resulting in a reduced helium leak rate.

In comparison of Examples 8 and 10 having the same outer sheet diameter (30 mm), Example 8 having a smaller inner sheet diameter showed a lower helium leak rate than Example 10. This suggests that the helium leak rate decreases when the width D11 of the first bonding area is larger than the width D12 of the second bonding area. The following may be the cause for this: In particular, in this test, theoretically, helium passes through the first bonding area to be temporarily entrapped in the non-bonding area (enclosed space 43) and then moves via the second bonding area towards opening 322. In this pathway, the concentration of helium entrapped in enclosed space 43 is significantly lower than that in internal space 33 of box 31. Accordingly, the amount of helium that further flows out of enclosed space 43 into the opening depends on the low concentration in enclosed space 43, resulting in a smaller amount than in an embodiment free of enclosed space 43.

As for why Examples 7 and 10 having the same outer sheet diameter (30 mm) had the same helium leak rate, the cause may have something to do with the widths of the first and second bonding areas while it is not particularly limited to this interpretation. It may be desirable that the first and second bonding areas have at least certain widths.

In this test, internal space 33 of box 31 was filled with helium and the helium inside box 31 moved into chamber 32. On the other hand, in the embodiment(s) described earlier, gases (e.g. a low-density gas such as helium) in internal space 130 of housing 120 and internal space 230 may leak out. Thus, internal space 33 of box 31 in this test may serve as internal space 130 of housing 120 and internal space 230 in the aforementioned embodiment. Inside of chamber 32 in this test may correspond to outside of housing 120 in the aforementioned embodiment. Enclosed space 43 in this test may correspond to enclosed space 150 or 250 in the aforementioned embodiment. Accordingly, in this test, the first bonding area's width D11 (which is the distance from the edge of outer sheet 42 to the edge of inner sheet 41) may correspond to the width of first bonding area D1 running from enclosed space 150 to gap 140 in the embodiment. In this test, the second bonding area's width D12 (which is the distance from the edge of inner sheet 41 adjacent to enclosed space 43 to opening 322 of lid 321) may correspond to the width of second bonding area D2 running from enclosed space 150 to the outer edge of PSA layer 20B. Conversely, when entrance of external moisture is to be prevented in the aforementioned embodiment, the roles of first and second bonding areas may be exchanged as a technical idea.

These test results indicate that the helium leak rate decreases in an embodiment having a non-bonding area (and further an enclosed space) as compared to an embodiment free of such an area. It is presumed that the helium leak rate further decreases when the width of first bonding area D1 is larger than the width of second bonding area D2.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1, 101, 201 cover seals
10, 10A, 10B, 11A, 11B gas barrier layers
20, 20A, 20B, 21A, 21B PSA layers
20E, 21E outer edges
100, 200 magnetic disc devices
101A, 201A first PSA sheets
101B, 201B second PSA sheets
102A, 202A edges
120, 220 housings
130, 230 internal spaces
140, 240 openings and/or gaps
150, 250 enclosed spaces (non-bonding areas)
D1 first bonding area
D2 second bonding area

What is claimed is:

1. An electronic device comprising a housing that forms an internal space to house components, the housing having an opening and/or gap through which gases can move between the internal space and outside of the housing; and further comprising a cover seal bonded to the housing, covering the opening and/or gap; wherein
the cover seal is formed of at least one pressure-sensitive adhesive sheet having a gas barrier layer and a pressure-sensitive adhesive layer provided at least on one face of the gas barrier layer, and
the housing and the cover seal share a bonding interface that has, along its surface, a first bonding area, a non-bonding area and a second bonding area in this order from the opening and/or gap towards the outside.

2. The electronic device according to claim 1, having an enclosed space between the pressure-sensitive adhesive layer's outer edge and the opening and/or gap.

3. The electronic device according to claim 1, wherein
the cover seal comprises a first pressure-sensitive adhesive sheet covering the opening and/or gap and a second pressure-sensitive adhesive sheet covering at least the outer edge of the first pressure-sensitive adhesive sheet; and
an enclosed space is formed adjacent to where the outer edge of the first pressure-sensitive adhesive sheet with the second pressure-sensitive adhesive sheet overlap.

4. The electronic device according to claim 3, wherein the second pressure-sensitive adhesive sheet entirely covers the first pressure-sensitive adhesive sheet bonded to the housing.

5. The electronic device according to claim 1, wherein the pressure-sensitive adhesive layer-bearing face of the cover seal has a circular recess.

6. The electronic device according to claim 1, wherein, along the bonding interface between the housing and the cover seal, the first bonding area has a width from the opening and/or gap to the non-bonding area and the second bonding area has a width from the non-bonding area to the pressure-sensitive adhesive layer's outer edge, with the first bonding area's width being larger than the second bonding area's width.

7. The electronic device according to claim 1, wherein the gas barrier layer has a moisture permeability below 5×10⁻¹ g/m², determined per 24 hours at 40° C. at 90% RH based on the MOCON method (JIS K7129:2008).

8. A cover seal comprising at least one pressure-sensitive adhesive sheet having a gas barrier layer and a pressure-sensitive adhesive layer provided to at least one face of the gas barrier layer, wherein the pressure-sensitive adhesive layer has an adhesive face that has, along its surface, a first bonding area, a non-bonding area and a second bonding area in this order.

9. The cover seal according to claim 8, having a moisture permeability lower than 90 μg/cm² in the in-plane direction of bonding area of pressure-sensitive adhesive sheet, determined per 24 hours at a permeation distance of 2.5 mm based on the MOCON method.

10. The cover seal according to claim 8, having an amount of thermally released gas of 10 μg/cm² or less, determined at 130° C. for 30 minutes by gas chromatography/mass spectrometry.

11. The cover seal according to claim 8, exhibiting a 180° peel strength of 3 N/20 mm or greater to stainless steel.

12. The cover seal according to claim 8, wherein the pressure-sensitive adhesive layer has a storage modulus below 0.5 MPa at 25° C.

13. The cover seal according to claim 8, wherein the pressure-sensitive adhesive layer is a rubber-based pressure-sensitive adhesive layer comprising a rubber-based polymer as its base polymer, an acrylic pressure-sensitive adhesive layer comprising an acrylic polymer as its base polymer, or a rubber-acrylic blend pressure-sensitive adhesive layer comprising a rubber-based polymer and an acrylic polymer as its base polymers.

14. The cover seal according to claim 8, wherein the pressure-sensitive adhesive layer is the rubber-based pressure-sensitive adhesive layer, wherein at least one species of monomer selected from the group consisting of butene, isobutylene and isoprene is polymerized in the rubber-based polymer.

15. The cover seal according to claim 8, used for sealing the internal space of an electronic device.

16. An electronic device having the cover seal according to claim 8.

17. The electronic device according to claim 16, wherein the disc device has an internal space sealed with the cover seal.

18. The electronic device according to claim 16, wherein the device has a housing base member whose top face is covered and sealed with the cover seal.

19. The electronic device according to claim 16, capable of heat-assisted magnetic recording.

20. A method for applying a cover seal to a housing that forms an internal space to house components so as to seal the internal space, the method comprising
a step of applying a cover seal to cover an opening and/or gap of the housing, wherein
the application step is a step of applying the cover seal so that the housing and the cover seal share a bonding interface that has, along its surface, a first bonding area, a non-bonding area and a second bonding area from the opening and/or gap towards the outside.
